(19) United States
(12) Patent Application Publication
(10) Pub. No.: US 2016/0148426 A1
(43) Pub. Date: May 26, 2016

(54) RENDERING METHOD AND APPARATUS

(71) Applicant: Samsung Electronics Co., Ltd., Suwon-si (KR)

(72) Inventors: Minyoung SON, Hwaseong-si (KR); Haewoo PARK, Seoul (KR); Minkyu JEONG, Yongin-si (KR); Donghoon YOO, Suwon-si (KR)

(73) Assignee: SAMSUNG ELECTRONICS CO., LTD., Suwon-si (KR)

(21) Appl. No.: 14/939,059

(22) Filed: Nov. 12, 2015

(30) Foreign Application Priority Data
Nov. 26, 2014 (KR) 10-2014-0166630

(51) Int. Cl. G06T 17/20; G06T 15/08; G06T 1/20

(52) U.S. Cl. CPC G06T 17/20; G06T 1/20; G06T 15/08

(57) ABSTRACT

Provided is a selective rendering apparatus and method. The method may include generating a domain visibility stream indicating which domains for an input patch are visible during rendering, generating domain information about one or more regions of the input patch based on the domain visibility stream, and performing selective domain shading on respective domains of the plurality of domains based on whether the domain visibility stream indicates that the respective domains are visible. The method may also, or alternatively, include generating a vertex visibility stream indicating visible vertices of an input patch or primitive and selectively vertex shading the vertices of the input patch or primitive based on the vertex visibility stream.

### CROSS-REFERENCE TO RELATED APPLICATION

This application claims the benefit of Korean Patent Application No. 10-2014-0166630, filed on Nov. 26, 2014, in the Korean Intellectual Property Office, the disclosure of which is incorporated herein in its entirety by reference.

### BACKGROUND

1. Field

One or more embodiments relate to rendering methods and apparatuses that include selective rendering.

2. Description of Related Art

A Rendering pipeline may include a tessellation stage, where polygons may be divided into smaller polygons. Such tessellation operations may be helpful to provide smoother rendered surfaces, greater realism, and dynamic levels of detail. Tessellation processes may vary depending on the application programming interface (API).

An input to such a tessellation stage may include a patch that includes a plurality of control points, while an output of such a tessellation stage may include a plurality of additional vertices. These vertices may then be used to form primitives that may ultimately be rendered and output to a display, for example.

### SUMMARY

This Summary is provided to introduce a selection of concepts in a simplified form that are further described below in the Detailed Description. This Summary is not intended to identify key features or essential features of the claimed subject matter, nor is it the Summary intended to be used as an aid in determining the scope of the claimed subject matter.

One or more embodiments include a rendering method, the method including generating a domain visibility stream indicating which domains of a plurality of domains for an input patch are visible, generating domain information about one or more regions of the input patch based on the domain visibility stream, and performing selective domain shading, using the domain information, on respective domains of the plurality of domains based on whether the respective domains are indicated as being visible by the domain visibility stream.

The method may further include partitioning the input patch to generate the plurality of domains, the plurality of domains corresponding to the regions of the input patch.

The generating of the domain visibility stream may further include generating the domain visibility stream based on respective location information of a vertex corresponding to each of the plurality of domains.

The generating of the domain visibility stream may be based only on the respective location information of the vertex corresponding to each of the plurality of domains and depth information for comparison with vertex depth information for each of the respective location information to determine visibility of each vertex corresponding to the plurality of domains.

The generating of the domain visibility stream may further include generating the domain visibility stream by performing respective depth tests on each of the plurality of domains.

When a first domain set includes all domains of the plurality of domains that are determined to be visible and a second domain set includes all domains of the plurality of domains that are determined to be invisible, the domain visibility stream may include an identifier of a domain included in whichever one of the first and second domain sets has a fewest number of domains, and a reverse flag distinguishing whether the domain is determined to be a visible domain or determined to be an invisible domain.

The performing of the selective domain shading may include skipping domain shading on domains indicated as being invisible by the domain visibility stream.

The method may further include generating a primitive assembly stream indicating whether at least one domain of the plurality of domains is assembled to a primitive, and performing primitive assembly on a vertex corresponding to the at least one domain and obtained as a result of the performing the selective domain shading, based on the primitive assembly stream.

The generating of the domain visibility stream may be performed in a first rendering pipeline, and the generating of the domain information and the performing of the selective domain shading may be performed in a second rendering pipeline.

The method may further include generating a vertex visibility stream respectively indicating whether each input vertex of the input patch is visible, and selectively performing vertex shading on an input vertex of the input patch based on whether the vertex visibility stream indicates that the input vertex is visible.

At least one of the input vertices of the input patch may be an input control point of the input patch.

One or more embodiments may include a rendering method, the method including generating a vertex visibility stream respectively indicating whether each of plural input vertices is visible, and selectively performing vertex shading on an input vertex, of the plural input vertices, based on whether the vertex visibility stream indicates that the input vertex is visible, where the vertex shading is performed using vertex information about the input vertex.

The method may further include generating a primitive assembly stream indicating whether at least one vertex of the plural input vertices is assembled to a primitive, and performing primitive assembly on a vertex obtained as a result of the performing of the vertex shading, based on the primitive assembly stream.

The vertex visibility stream and the primitive assembly stream may be generated in a first rendering pipeline and vertex shading may be performed only in the second rendering pipeline.

The method may further include partitioning a patch, derived from a result of the vertex shading, to generate a plurality of domains, the plurality of domains corresponding to partitioned regions of the input patch, generating a domain visibility stream indicating which domains of the plurality of domains for the patch are visible, and performing selective domain shading on respective domains, of the plurality of domains, based on whether the respective domains are indicated as being visible by the domain visibility stream.

One or more embodiments may include a rendering apparatus including one or more rendering pipelines respectively including a partitioning processing element and a domain shading processing element, configured to implement a first rendering pipeline sequence using a first rendering pipeline of the one or more rendering pipelines to generate a domain visibility stream indicating which of a plurality of domains for the input patch are visible regions and configured to implement a second rendering pipeline sequence using the first rendering pipeline or another rendering pipeline of the one or more rendering pipelines to generate domain information about one or more regions of the input patch based on the domain visibility stream and to perform selective domain shading, using the domain information, on respective domains of the plurality of domains based on whether the respective domains are indicated as being visible by the domain visibility stream.

The partitioning processing element of the first rendering pipeline may be configured to partition the input patch to identify the plurality of domains in the first rendering pipeline sequence.

In the first rendering pipeline sequence, the first rendering pipeline may generate the domain visibility stream based on respective location information of a vertex corresponding to each of the plurality of domains.

In the first rendering pipeline sequence, the first rendering pipeline may generate the domain visibility stream by performing respective depth tests on each of the plurality of domains.

In the second rendering pipeline sequence, the first rendering pipeline or the other rendering pipeline may skip domain shading on domains indicated as being invisible by the domain visibility stream.

In the second rendering pipeline sequence, the first rendering pipeline may generate a primitive assembly stream indicating whether at least one domain of the plurality of domains is assembled to a primitive, and the first rendering pipeline or the other rendering pipeline may perform primitive assembly on a vertex corresponding to the at least one domain and obtained as a result of the performing the selective domain shading, by using the primitive assembly stream.

The first rendering pipeline and the other rendering pipeline may each further include a vertex shading processing element, configured to generate, in the first rendering pipeline sequence, a vertex visibility stream respectively indicating which input vertex of the input patch is visible, and configured to selectively perform, in the second rendering pipeline sequence, selective vertex shading on an input vertex of the input patch based on whether the vertex visibility stream indicates that the input vertex is visible.

At least one of the input vertices of the input patch may be an input control point of the input patch.

One or more embodiments include a rendering apparatus including one or more rendering pipelines respectively including a vertex shader processing element, configured to implement a first rendering pipeline sequence using a first rendering pipeline of the one or more rendering pipelines to generate a vertex visibility stream respectively indicating which of plural input vertices is visible, and configured to implement a second rendering pipeline sequence using the first rendering pipeline or another rendering pipeline of the one or more rendering pipelines to selectively perform vertex shading on an input vertex, of the plural input vertices, based on whether the vertex visibility stream indicates that the input vertex is visible, where the vertex shading is performed using vertex information about the input vertex.

The first rendering pipeline and the other rendering pipeline may each further include a primitive assembly processing element, configured to generate, in the first rendering pipeline sequence, a primitive assembly stream indicating whether at least one vertex of the input vertices is assembled to a primitive, and configured to performs primitive assembly, in the second rendering pipeline sequence, on a vertex obtained as a result of the vertex shading based on the primitive assembly stream.

One or more embodiments may include a rendering method, the method including partitioning an input patch or primitive to generate a plurality of domains representing partitioned regions of the input patch, generating domain visibility information respectively indicating which of the plurality of domains are visible, and performing selective domain shading on domains of the plurality of domains based on the domain visibility stream.

The performing of the selective domain shading may include only performing domain shading on domains of the plurality of domains that are indicated as being visible by the domain visibility stream.

The performing of the selective domain shading may include performing domain shading on domains of the plurality of domains that are indicated as being visible by the domain visibility stream differently from domain shading performed on domains of the plurality of domains that are indicated as being invisible by the domain visibility stream.

The generating of the domain visibility stream may be performed in a first rendering pipeline, and the generating of the domain information and the performing of the domain shading may be performed in a second rendering pipeline.

The first rendering pipeline and the second rendering pipeline may be a same rendering pipeline of a graphical processing unit (GPU) core, respectively sequentially operated in a first and second pass of the GPU core.

The domains may be polygonal, triangular, and/or isoline domains respectively representing the partitioned regions of the input patch.

The domains may be domain vertices of the partitioned regions of the input patch.

The method may further include generating a vertex visibility stream respectively indicating whether input vertices of the input patch or primitive are visible, and selectively performing vertex shading on an input vertex of the input patch or primitive based on whether the vertex visibility stream indicates that the input vertex is visible, wherein the partitioning of the input patch or primitive is performed using results of the selectively performed vertex shading so as to not partition a region or vertex of the input patch or primitive that is determined to be invisible and is not vertex shaded in the selective performing of the vertex shading.

At least one of the input vertices of the input patch may be an input control point of the input patch.

One or more embodiments may include a non-transitory recording medium including processing code to control at least one processing device to implement one or more methods set forth in the below disclosure.

Additional aspects will be set forth in part in the description which follows and, in part, will be apparent from the description, or may be learned by practice of the, as only examples, presented embodiments.

### BRIEF DESCRIPTION OF THE DRAWINGS

These and/or other aspects will become apparent and more readily appreciated from the following description, taken in conjunction with the accompanying drawings in which:

FIG. 1 is a conceptual diagram for describing a method of performing selective tessellation, according to one or more embodiments;

FIG. 2 is a flowchart of a method of performing selective tessellation, according to one or more embodiments;

FIG. 3 is a diagram describing a method of performing selective tessellation, such as the method of performing selective tessellation of FIG. 2, according to one or more embodiments;

FIG. 4 is a diagram describing a structure of a domain visibility stream, according to one or more embodiments;

FIG. 5 is a flowchart of a method of performing selective tessellation based on a visibility stream and a primitive assembly stream, according to one or more embodiments;

FIG. 6 is a diagram describing a method of performing selective tessellation, such as the method of performing selective tessellation of FIG. 5, according to one or more embodiments;

FIG. 7 is a flowchart of a method of performing selective vertex shading, according to one or more embodiments;

FIGS. 8 and 9 are diagrams describing methods of performing selective vertex shading, such as the method of performing selective vertex shading of FIG. 7, according multiple embodiments;

FIGS. 10 through 13 are diagrams describing example generations of domain visibility streams and primitive assembly streams, according to one or more embodiments;

FIG. 14 is a diagram for describing a generating of a vertex visibility stream and a primitive assembly stream, according to one or more embodiments; and

FIG. 15 is a block diagram of a rendering apparatus, according to multiple embodiments.

### DETAILED DESCRIPTION

The following detailed description is provided to assist the reader in gaining a comprehensive understanding of the methods, apparatuses, and/or systems described herein. However, after an understanding of the present disclosure, various changes, modifications, and equivalents of the methods, apparatuses, and/or systems described herein will be apparent to one of ordinary skill in the art. The sequences of operations described herein are merely examples, and are not limited to those set forth herein, and may be changed as will be apparent to one of ordinary skill in the art, with the exception of operations necessarily occurring in a certain order. In addition, descriptions of functions and constructions that may be well known to one of ordinary skill in the art may be omitted for increased clarity and conciseness.

The features described herein may be embodied in different forms, and are not to be construed as being limited to the examples described herein.

Various alterations and modifications may be made to the embodiments, some of which will be illustrated in detail in the drawings and detailed description. However, it should be understood that these embodiments are not construed as limited to the illustrated forms and include all changes, equivalents, or alternatives within the idea and the technical scope of this disclosure.

Terms used herein are to merely explain specific embodiments, thus are not meant to be limiting. A singular expression includes a plural expression except when two expressions are contextually different from each other. For example, as used herein, the singular forms “a,” “an” and “the” are intended to include the plural forms as well, unless the context clearly indicates otherwise. Herein, a term “include” or “have” are also intended to indicate that characteristics, figures, operations, components, or elements disclosed on the specification or combinations thereof exist. The term “include” or “have” should be understood so as not to pre-exclude the existence of one or more other characteristics, figures, operations, components, elements or combinations thereof or additional possibilities.

In addition, such terms as “first”, “second”, etc., may be used to describe various components, such components must not be limited to the above terms. The above terms are used only to distinguish one component from another.

Unless otherwise defined, all terms including technical and scientific terms used herein have the same meaning as commonly understood by one of ordinary skill in the art to which this invention may belong, in view of the present disclosure. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Herein, a “domain visibility stream” may indicate whether each of at least one domain for an input patch is visible during rendering. A domain visibility stream may also indicate whether a fragment formed by such domains is visible during rendering. For example, even when each of the domains forming a fragment is invisible during rendering, the fragment formed by such domains may still be visible during rendering. Thus, to further address visibility when each domain forming a fragment is invisible during rendering, a domain visibility stream may include information indicating whether the fragment formed by the invisible domains is visible during rendering. As only examples, a domain visibility stream may be formed as a bit stream, an index range, an index set, a bit map, and an index stream.

Herein, a “primitive assembly stream” may indicate whether a domain or a vertex is to be assembled to a primitive, and in result, may indicate whether such a primitive is visible. As only examples, a primitive assembly stream may be formed as a bit stream, an index range, an index set, a bit map, and an index stream.

Herein, a “vertex visibility stream” may indicate whether each of at least one vertex, e.g., of an input patch, is visible during rendering. A vertex visibility stream may also indicate whether a fragment formed by multiple vertices is visible during rendering. For example, even when each of the vertices forming a fragment is invisible during rendering, the fragment formed by such vertices may still be visible during rendering. Thus, to further address visibility when each of vertices forming a fragment is invisible during rendering, a vertex visibility stream may include information indicating whether the fragment formed by the invisible vertices is visible during rendering. As only examples, a vertex visibility stream may be formed as a bit stream, an index range, an index set, a bit map, and an index stream.

Hereinafter, certain embodiments will be explained in more detail with reference to the attached drawings, wherein like reference numerals refer to like elements throughout. Like or the same component or components corresponding to each other will be provided with the same reference numeral, and their detailed explanation may be omitted. In addition, when it is determined that a detailed description of a related or known function or configuration may make a purpose of an embodiment of the present disclosure unnecessarily ambiguous, such a detailed description may be omitted.

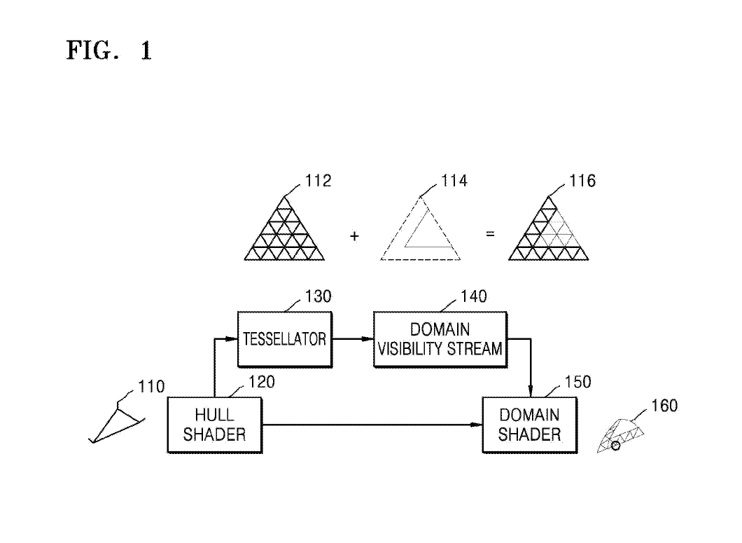

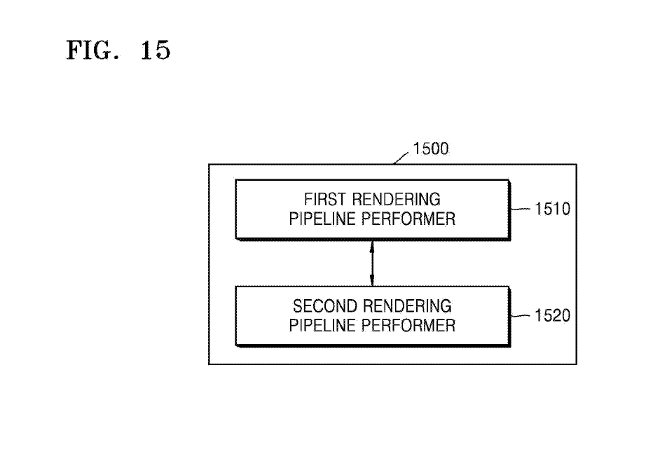

FIG. 1 is a conceptual diagram describing a method of performing selective tessellation, according to one or more embodiments. The selective tessellation may be included in a rendering method embodiment, such as the rendering process described below with regard to the rendering apparatus of FIG. 15, as only an example.

For example, as shown in FIG. 1, a rendering apparatus may implement the selective tessellation by selectively performing domain shading in a tessellation stage of a rendering process. For example, the rendering apparatus may perform domain shading only on domains that are visible during rendering, based on the example domain visibility stream 140. Herein, as only an example, selective tessellation and selective vertex shading will be discussed as being implemented in a Directx11 rendering pipeline environment, where the tessellation stage of the Directx11 rendering pipeline may include a hull shader, a tessellator, and a domain shader. Directx11 is used as an example application programming interface (API), but a type of API is not limited thereto, and processes of the underlying rendering pipeline are not limited those defined in Directx11. As only an example, such below discussed selective tessellation, e.g., based on a domain visibility stream, and/or selective vertex shading, e.g., based on a vertex visibility stream, may also be implemented in an OpenGL 4.x rendering pipeline embodiment. In the OpenGL 4x rendering pipeline, the corresponding tessellation stage may sequentially include a corresponding control shader, a primitive generator, and an evaluation shader, for example.

In an embodiment that includes a Directx11 rendering pipeline, as noted, the tessellation process may include an input patch 110 being processed and output as vertices 160 through operation of a hull shader 120, a tessellator 130, and a domain shader 150, for example.

In an embodiment, a rendering apparatus may generate information 114 distinguishing a visible region and an invisible region during rendering, through a tessellation process 112 that partitions or divides the input patch 110 into small polygons during a first rendering pipeline. Then, while performing a second rendering pipeline, the rendering apparatus may perform a rendering operation, such as domain shading, only on a visible region 116 for an input patch by using the information 114. Such domain shading may be skipped for all domains in the first rendering pipeline. Here, information 114 may also be demonstrative of a domain mask that may identify which domains are visible, for example. In other words, in an embodiment, during the second rendering pipeline, the tessellator 130 may generate or update domain information only for visible domains, and the domain shader 150 may then skip domain shading on the invisible domains. Accordingly, because the domain shader 150 does not have to perform domain shading on domains that ultimately would not need to be rendered in a subsequent rendering stage, i.e., because such domains would not be visible to a viewer, unnecessary memory use and traffic may be reduced, and power consumption during a graphic process using a graphic processing unit (GPU) may be reduced. Here, the first rendering pipeline may include a simplified examination of the input patch, such as performing the pipeline with only location information and depth information for a corresponding scene, as only an example, to generate the example domain mask or information 114, for example, so that only domains or domain vertices generated by the tessellator 130 that are visible are operated on by the domain shader 150 during the second rendering pipeline.

Briefly, as noted, the patch may represent a surface of an object. The tessellator 130 may partition or divide the patch, or one or more predetermined primitives of such a patch, into polygons, triangles, and/or lines, e.g., into polygon, triangle, and/or line domains. For example, the tessellator 130 may identify such polygon, triangle, or line domains by their domain vertices whose locations may be transmitted as coordinates by the tessellator 130 to the domain shader 150.

In addition or in the alternative, and as will be discussed further below in greater detail, such a sequenced process may be expanded and applied to other processes of the rendering pipeline. For example, first and second pipeline operations may be applied to selectively perform vertex shading so as to reduce throughput during rendering. The rendering apparatus may generate a vertex visibility stream indicating visibility during rendering while performing a first rendering pipeline, and perform vertex shading only on visible vertices by using the vertex visibility stream while performing a second rendering pipeline.

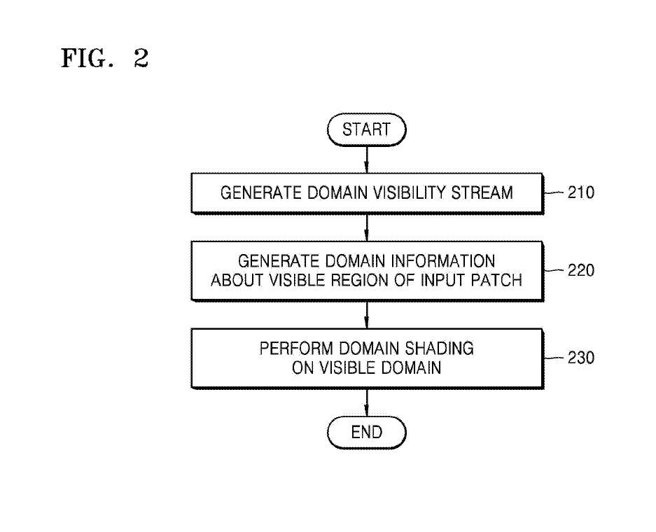

FIG. 2 is a flowchart of a method of performing selective tessellation, according to one or more embodiments. Similar to above, the selective tessellation may be included in a rendering method embodiment, such as the rendering process described below with regard to the rendering apparatus of FIG. 15, as only an example.

In operation 210, a rendering apparatus may generate a domain visibility stream indicating whether at least one domain for an input patch is visible during rendering.

The rendering apparatus may generate the domain visibility stream by performing a first rendering pipeline using location information, i.e., less than all pieces of information regarding the input patch and corresponding domains, about the vertices corresponding to each domain for the input patch. Here, the first rendering pipeline may be a process for determining visibility of the domains. As noted above, this location based first rendering pipeline may be performed to obtain a domain visibility stream because the overhead may otherwise be too large if the rendering pipeline were to be performed using all pieces of information regarding the input patch and corresponding domains that may be used for domain shading. Thus, in an embodiment, the rendering apparatus may perform the first rendering pipeline by using less than all of these pieces of information, such as only using the location information about the corresponding vertices and depth information for a corresponding scene, as only an example.

In an embodiment, the rendering apparatus may generate the domain visibility stream, indicating the visibility of each domain during rendering, based on a depth test performed on each domain for the input patch. As only an example, a domain that passes the depth test may be a domain that is at a depth so as to not be obstructed by other objects of a scene, and is thus a domain that is visible during rendering, while a domain that fails the depth test may be a domain that is at a depth so as to be obstructed by other objects of the scene, and is thus a domain that is not visible during rendering. A domain that is visible during rendering may be referred to as a visible domain, while a domain that not visible during rendering may be referred to as an invisible domain. Such confirmed visibility determinations are also applicable for when determining whether vertices are visible during rendering and when determining whether patches and primitives are assembled.

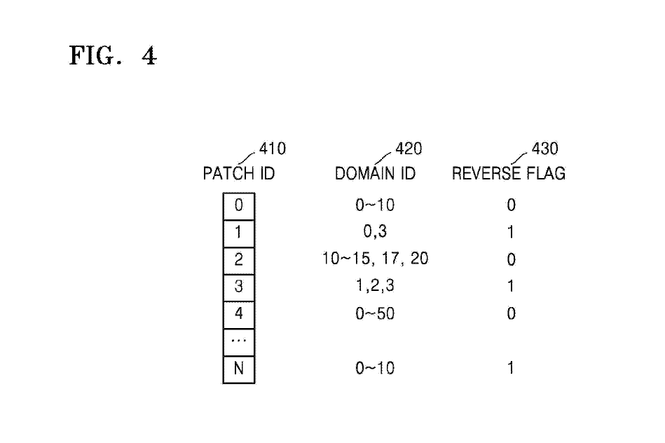

Thus, the domain visibility stream may include information indicating the visibility of each domain for the input patch, e.g., with the inclusion and lack of inclusion of domain identifications in the domain visibility stream indicating the visibility of each domain. As only an example, a structure for the domain visibility stream will be described later with reference to FIG. 4.

The rendering apparatus according to an embodiment may additionally generate a primitive assembly stream in the first rendering pipeline indicating whether such domains are assembled to a primitive.

In operation 220, in a second rendering pipeline, the rendering apparatus may generate domain information about a visible region of the input patch by using the domain visibility stream.

For example, the rendering apparatus may transmit barycentric coordinates to a domain shader according to an operation of a tessellator, such as the tessellator 130 of FIG. 1. For example, in an embodiment, a hull shader may have determined a desired level of detail (LOD) for an object or corresponding input patch, and a tessellator may have then implemented the LOD for the partitioning or dividing of the patch, or one or more predetermined primitives of such patches, into polygons, triangles, and/or lines, e.g., into polygon, triangle, and/or line domains. Such polygon, triangle, or line domains may be identified by the tessellator by their domain vertices that are transmitted as such barycentric coordinates to the domain shader. As an example, the LOD may be determined based on a viewing distance to the object, e.g., with a greater LOD and, thus, more partitioning or divisions of one or more of the object's patches when the viewing distance is short and less LOD and, thus, less partitioning or divisions of the one or more object's patches when the viewing distance is large. This may provide a dynamic LOD that can increase the number of partitions or divisions to selectively increase an amount of viewed detail of an object and selectively reduce the number of partitions to decrease the viewed detail of the object. This dynamic LOD can save power and increase processing speed.

Referring back to FIG. 2, based on the generated domain information, a second rendering pipeline may be performed for displaying a scene on an actual screen or display of an electronic device embodiment, such that more information is processed in the second rendering pipeline than the first rendering pipeline of operation 210. For example, in operation 230, the domain shader may perform domain shading on visible domains in the second rendering pipeline, while such domain shading may not be performed in the first rendering pipeline. As noted above, compared to an operation where an input patch is operated on by a hull shader, then tessellated, and then all resultant domains shaded by a domain shader in a single pipeline rendering, in one or more embodiments an overhead can be reduced since a domain that is not visible during rendering is not domain shaded in either rendering pipeline, for example.

As noted, the rendering apparatus according to an embodiment may not generate or update domain information about an invisible domain during rendering, i.e., during the operation of the second pipeline rendering. Accordingly, unnecessary operations and memory use may be reduced.

Thus, in operation 230, during the second pipeline rendering, the rendering apparatus may perform domain shading on a visible domain based on the domain information generated in operation 220.

Here, in the example Directx11 rendering pipeline, “domain shading” by the domain shader may include disparity or coordinate conversion that is performed by giving a 3-dimensional (3D) meaning to a polygon represented by the partitioning or division of the object in the tessellation operation. In an OpenGL 4.x rendering pipeline embodiment, a tessellation evaluation shader in OpenGL 4.x may perform a similar domain shading operation.

Thus, based on the domain visibility stream, the rendering apparatus may skip domain shading on a domain that is indicated to be invisible by the domain visibility stream. In addition, during subsequent processes of the rendering pipeline, some rendering processes may be selectively skipped for such indicated invisible regions, which would further reduce unnecessary operations and memory use.

The rendering apparatus may obtain a vertex as an output of the domain shader, and may further generate a primitive by assembling the obtained vertices.

As explained in greater detail further below, the rendering apparatus according to an embodiment may perform primitive assembly on the vertices obtained as a result of the domain shading, by using a primitive assembly stream.

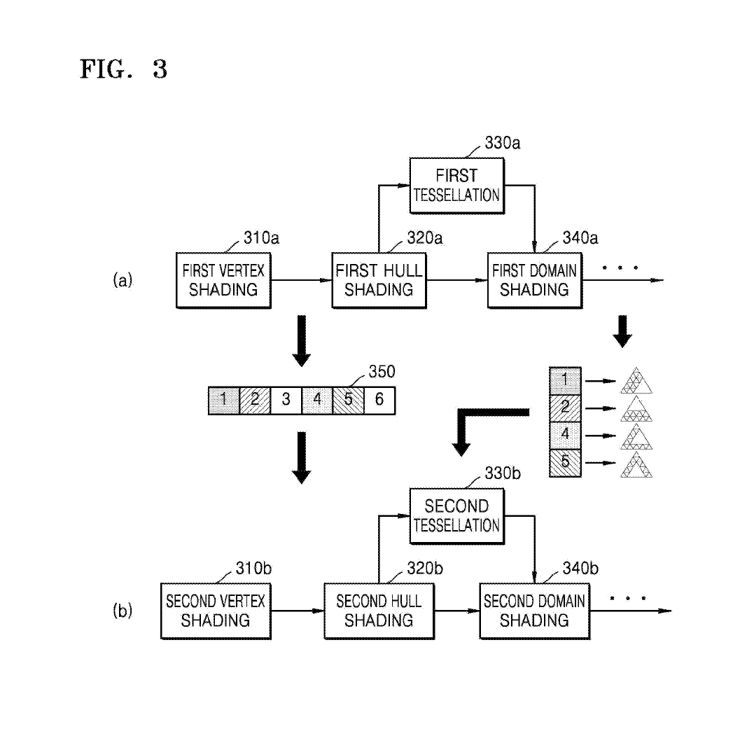

FIG. 3 is a diagram describing a method of performing selective tessellation, such as the method of performing selective tessellation of FIG. 2, according to one or more embodiments.

Thus, FIG. 3 illustrates a 2-pass tessellation process. In illustration (a), FIG. 3 demonstrates a first tessellation process for generating a domain visibility stream by determining visibility of a domain. In illustration (b), FIG. 3 demonstrates a second tessellation process for actual rendering, wherein a rendering process is performed on an indicated visible domain based on the generated domain visibility stream. As only an example of the actual rendering, such a rendering process may include domain shading on the indicated visible domains, with domain shading of domains not having been performed in the first tessellation process.

According to an embodiment, the first tessellation process of FIG. 3 and the second tessellation process of FIG. 3 may be performed in one GPU core or pipeline. For example, a vertex shader may sequentially perform first vertex shading 310a and second vertex shading 310b. Likewise, a hull shader may sequentially perform first hull shading 320a and second hull shading 320b, a tessellator may sequentially perform first tessellation 330a and second tessellation 330b, and a domain shader may sequentially perform first domain shading 340a and second domain shading 340b.

The vertex shader may perform functions of managing an input patch when the tessellator operates. The vertex shader may transmit the input patch to the hull shader.

The hull shader may set a tessellation factor for determining the number of polygons into which each input patch is to be partitioned or divided, and transmit the tessellation factor to the tessellator. The tessellator may, thus, subdivide input patches, e.g., of a 3D object, into a plurality of smaller output primitives, for example, into triangle, quad, and/or isoline domains, according to the tessellation factor provided from the hull shader. An output of the tessellator may be a set of vertices defining the output primitives, e.g., domain vertices representing vertices of the triangle, quad, and/or isoline domains. The domain shader may process the output vertices generated by the tessellator. The domain shader may calculate various attributes based on locations of the output vertices and control points of the input patch received from the hull shader. Accordingly, it is possible to render a smoother curved surface for expressing graphically more detailed images compared to a rendering of the original patch without such tessellation.

According to an embodiment, the first tessellation process and the second tessellation process may alternatively be performed by separate GPUs or GPU cores of the example rendering apparatus.

Referring to illustration (a) of FIG. 3, during the first tessellation process, the rendering apparatus may generate a domain visibility stream for each input patch by determining whether a domain for each input patch will be visible during rendering. Thus, the first tessellation process is a process that generates the domain visibility stream, e.g., performed based on location information about a vertex. In an embodiment, the first tessellation process may generate the domain visibility stream based only on the location information for the domain vertices and depth information regarding the corresponding scene, as only an example, e.g., with such location information also including depth information for vertex.

For example, identifiers 1 through 6 of an input patch stream 350 respectively represent first through sixth patches. Thus, the input patch stream 350 illustrates, through shading, that that the first, second, fourth, and fifth patches are visible and through non-shading that the third and sixth patches are invisible. In other words, the input patch stream 350 indicates that all domains for each of the third and sixth patches from among input patches would be invisible. In an embodiment, if such patch invisibility information is known, in this case tessellation may not even be performed for the third and sixth patches. Accordingly, the rendering apparatus may generate and store a domain visibility stream for each of the first, second, fourth, and fifth patches that are visible, from among the input patches. Such a first, second, fourth, and fifth domain visibility streams are illustrated to the right of the illustrated input patch stream 350 in FIG. 3.

During the second tessellation process, the rendering apparatus according to an embodiment may search for a domain visibility stream matching an input patch, e.g., based on the corresponding identifier of the input patch stream 350, that is to be currently processed.

Thus, when the second tessellation 330b is performed on the first patch, the first domain visibility stream matching the first patch is used to generate domain information about a domain that is indicated to be visible by the first domain visibility stream, such that the second domain shading 340b may be performed only on a visible domain for the first patch by using the generated domain information. For example, the corresponding domain shader may only be provided domain information regarding the visible domains and, thus, only perform domain shading on the visible domains. Alternatively, in an embodiment, the second domain shading 340b may be performed on the visible domains and invisible domains, with a dummy value(s) being used for the respective location of the invisible domains in the second domain shading 340b. The resultant domain shading output for the invisible domains may then be easily culled after the second domain shading 340b. As still another alternative, different amounts or the extent of domain shading may be performed differently, or minimally performed, by the second domain shading 340b for the invisible domains, while full domain shading may be performed on the visible domains.

Similarly, when the second tessellation 330b is performed on the second patch, a second domain visibility stream matching the second patch is used to generate domain information about a domain indicated to be visible by the second domain visibility stream, such that the second domain shading 340b may be performed only on a visible domain for the second patch by using the domain information.

As such, a rendering apparatus according to an embodiment may skip a rendering process for an input patch indicated as having only invisible domains, from among input patches, generate domain information about each visible domain for an input patch indicated as having visible domains, and perform domain shading only on the visible domains for the input patch. Accordingly, the rendering apparatus may reduce the necessary throughput during the second domain shading 340b by skipping rendering processes on invisible domains.

FIG. 4 is a diagram describing a structure of a domain visibility stream, according to one or more embodiments.

For each of the identified input patches 410, a domain visibility stream may be generated and respectively include information indicating visibility of each domain for each respective input patch. Referring to FIG. 4, the identified input patches 410 are distinguished from each other by identifiers (IDs) 0 through N. Information indicating the visibility of domains for an input patch may include IDs of a set of the domain(s), e.g., included in a domain set 420, and a reverse flag 430 that identifies the visibility or invisibility of that set of domain(s). In the example of FIG. 4, each illustrated set of IDs of the domain set 420 has a fewer number of domains from among a visible domain set and an invisible domain set. The reverse flag 430 indicates whether all domains included in the domain set 420, having the fewer number of identified domains, are visible domains or invisible domains.

For example, in FIG. 4, when the reverse flag 430 is 0, the corresponding domains identified in the domain set 420 are visible, and when the reverse flag 430 is 1, the corresponding domains identified in the domain set 420 are invisible. Thus, FIG. 4 illustrates that for the patch having an ID of 0, domains having IDs from 0 through 10 are visible. Similarly, for the patch having an ID of 1, domains having IDs from 0 through 3 are invisible, for the patch having an ID of 2, domains having IDs from 10 through 15, 17, and 20 are visible, for the patch having an ID of 3, domains having IDs from 1 through 3 are invisible, for the patch having an ID of 4, domains having IDs from 0 through 50 are visible, and for the patch having an ID of N, domains having IDs from 0 through 10 are invisible.

Since the reverse flag 430 distinguishes between visible and invisible domains, for each identified input patch 410, the reverse flag 430 may be stored with the IDs of the domains included in the domain set 420.

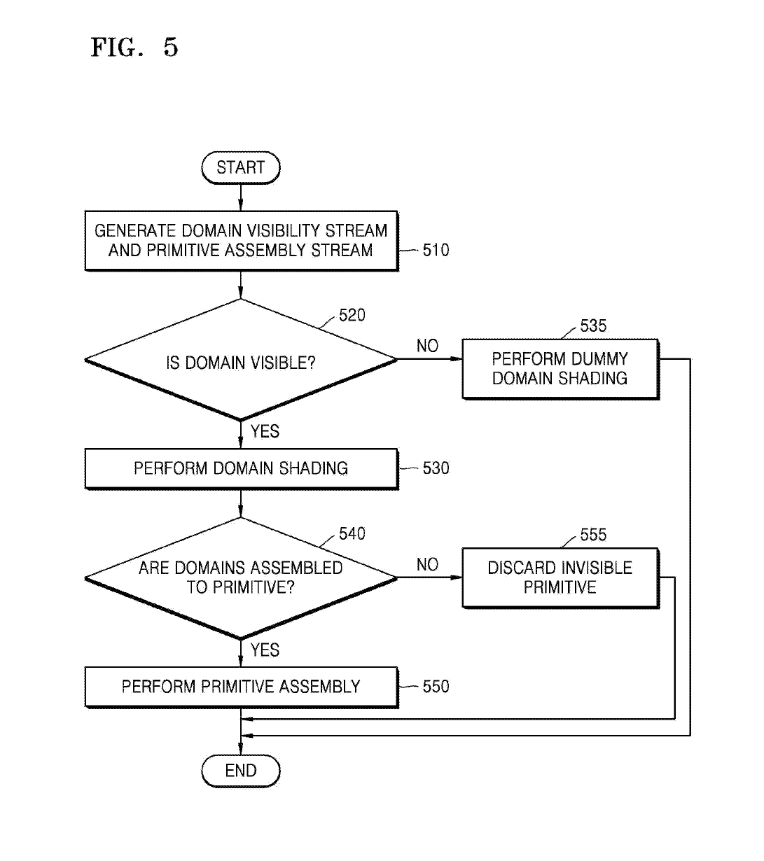

FIG. 5 is a flowchart of a method of performing selective tessellation based on a visibility stream and a primitive assembly stream, according to one or more embodiments.

In operation 510, a rendering apparatus may generate a domain visibility stream and a primitive assembly stream while performing a first rendering pipeline.

Since the generating of the domain visibility stream in operation 510 corresponds to operation 210 of FIG. 2, overlapping descriptions are not provided again.

In the first rendering pipeline, the rendering apparatus according to an embodiment may also obtain the primitive assembly stream by using respective location information about the vertices of the domains and the knowledge of whether such domains are visible.

The primitive assembly stream indicates whether respective domains or vertices, e.g., as generated by a tessellation process of each input patch, are assembled to primitives. In other words, the primitive assembly stream indicates whether such a primitive represented by the domains or vertices will be visible during rendering.

In operation 520, during a second rendering pipeline, the rendering apparatus determines whether a domain is visible by using the domain visibility stream generated during the first rendering pipeline. When it is determined that the domain is visible, operation 530 is performed, and when it is determined that the domain is not visible, operation 535 may be performed.

In operation 530, the rendering apparatus generates domain information about the domain determined to be visible and performs domain shading during the second rendering pipeline.

Since operation 530 corresponds to operations 220 and 230 of FIG. 2, overlapping descriptions are not provided again.

In operation 535, and still during the second rendering pipeline, the rendering apparatus may perform dummy domain shading on a domain determined to be invisible.

The dummy domain shading may be implemented by performing minimized domain shading or a similar operation on the domain determined to be invisible. For example, the dummy domain shading may be performed by performing domain shading using only a location of the domain determined to be invisible. Alternatively, as noted above, the dummy domain shading may be performed by generating a dummy value for location information of the domain determined to be invisible. Here, the dummy value may indicate a value pre-stored in a memory so as to reduce memory use. In an embodiment, since such dummy domain shading may not need or use a result of a domain shading on a domain determined to be invisible, throughput may be reduced, thereby reducing an overhead.

In operation 540, during the second rendering pipeline, the rendering apparatus determines whether the domains are to be assembled to a primitive by using the primitive assembly stream. When it is determined that the domains are to be assembled to a primitive, operation 550 is performed and when it is determined that the domains are not to be assembled to a primitive, operation 555 is performed.

In operation 550, during the second rendering pipeline, the rendering apparatus performs primitive assembly on vertices obtained by the domain shading. For example, the rendering apparatus may generate a triangular primitive by using three vertices. As a result, the rendering apparatus may assemble a visible primitive from visible domains. In an embodiment, the rendering apparatus may output the visible primitive to a rasterizer stage of the rendering apparatus embodiment, for example, and ultimately output the rasterized information to a display of an electronic device embodiment as the rendering apparatus. Accordingly, in an embodiment, the rendering apparatus is an electronic device that includes such a display and the aforementioned rendering stages and is configured to display the rendered primitive to a viewer.

In operation 555, the rendering apparatus discards an invisible primitive during the second rendering pipeline.

The rendering apparatus according to an embodiment may remove a primitive generated with a dummy value by using the primitive assembly stream.

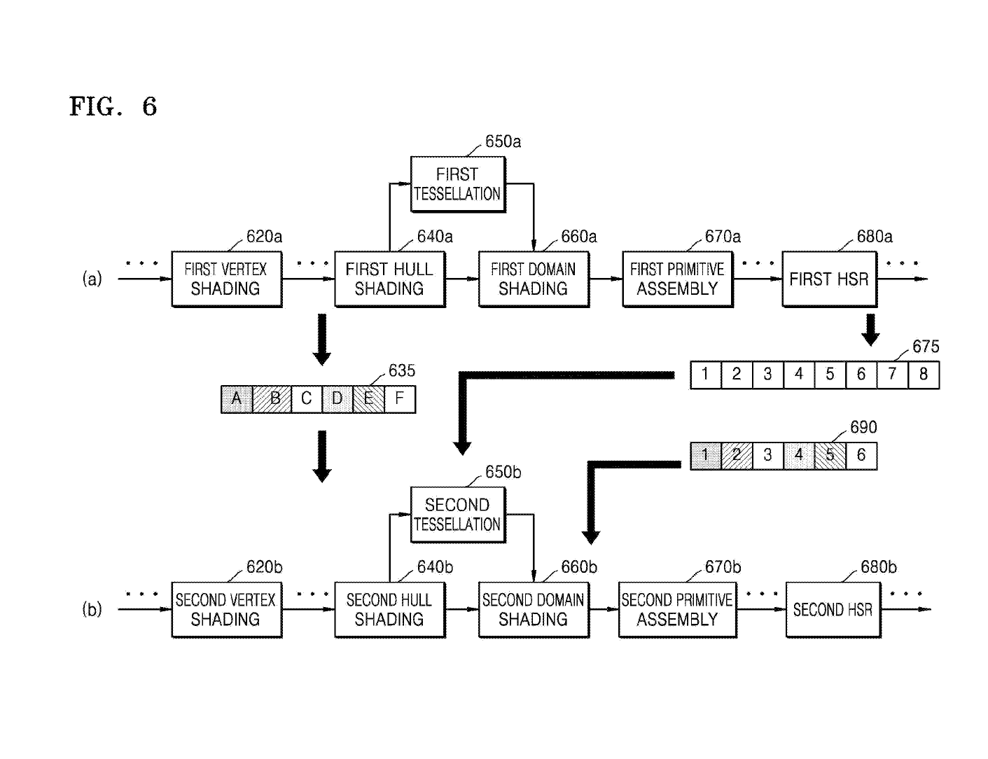

FIG. 6 is a diagram describing a method of performing selective tessellation, such as the method of performing selective tessellation of FIG. 5, according to one or more embodiments.

Descriptions overlapping those of FIG. 3 are not provided again. In detail, since first and second vertex shading 620a and 620b, first and second hull shading 640a and 640b, first and second tessellation 650a and 650b, and first and second domain shading 660a and 660b of FIG. 6 respectively correspond to the first and second vertex shading 310a and 310b, the first and second hull shading 320a and 320b, the first and second tessellation 330a and 330b, and the first and second domain shading 340a and 340b of FIG. 3, overlapping descriptions thereof are not provided again.

FIG. 6 illustrates a 2-pass rendering pipeline, e.g., of a rendering apparatus, such as the rendering apparatus of FIG. 15. Illustration (a) of FIG. 6 demonstrates a first rendering pipeline for generating a domain visibility stream 675 and a primitive assembly stream 690. Illustration (b) of FIG. 6 demonstrates a second rendering pipeline for actual rendering, which performs rendering processes on visible domains based on the domain visibility stream 675 and the primitive assembly stream 690. Such an actual rendering process may include domain shading, whose shading operations may be only performed in the second rendering pipeline, for example.

A rendering method according to an embodiment may be performed in a GPU. A GPU may be an exclusive processor designed to quickly manipulate data by using a high-degree of parallel structure. In detail, in one or more embodiments, a GPU may be configured to execute programmable stages or stages having fixed functions of a rendering pipeline in order to perform graphical processing. According to an embodiment, a GPU may be configured to execute a 3D graphics rendering pipeline in order to render 3D objects to a 2D space for display. For example, a GPU may perform rendering operations, such as shading, blending, and illuminating, and rendering operations for generating pixel values of pixels to be displayed on a display unit of a device embodiment, for example. According to an embodiment, before performing a rendering operation, such as shading, blending, or illuminating, a GPU may perform a binning pass that is also referred to as a tiling function. In a tile-based rendering architecture, tiles of an entire frame may be separately rendered, and then combined for display.

A device according to an embodiment may include a plurality of GPUs or GPU cores. Graphics processing tasks may be split between the GPUs or GPU cores.

According to an embodiment, the first rendering pipeline of FIG. 6 and the second rendering pipeline of FIG. 6 may be performed in one GPU core. In other words, a vertex shader may sequentially perform the first vertex shading 620a and the second vertex shading 620b. Likewise, a hull shader may sequentially perform the first hull shading 640a and the second hull shading 640b, a tessellator may sequentially perform the first tessellation 650a and the second tessellation 650b, a domain shader may sequentially perform the first domain shading 660a and the second domain shading 660b, a primitive assembler may sequentially perform first primitive assembly 670a and second primitive assembly 670b, and a hidden surface removal element (HSR) may sequentially perform first HSR 680a and second HSR 680b.

Alternatively, according an embodiment, the first rendering pipeline and the second rendering pipeline may be performed by respective GPUs or GPU cores.

In the first rendering pipeline, the rendering apparatus may determine whether domains for each input patch will be visible during rendering and accordingly generate the domain visibility stream 675 for the each input patch. In addition, the rendering apparatus may generate the primitive assembly stream 690 in the first rendering pipeline, indicating whether domains are to be assembled to a primitive. In an embodiment, the first rendering pipeline may be performed by only using information required to generate the domain visibility stream 675 and the primitive assembly stream 690.

For example, identifiers A through F of an input patch stream 635 respectively indicate the respective IDs of the first through sixth patches of the input patch stream 635. Thus, in the second rendering pipeline, the rendering apparatus may perform domain shading on the visible domains based on the generated domain visibility stream 675 matching each input patch. As an example, the domain visibility stream 675 of FIG. 6 is illustrated as including information indicating whether domains having IDs of 1 through 8, for one of the first through sixth patches of the input patch stream 635, are respectively visible. The primitive assembly stream 690 includes information indicating whether the domains having IDs of 1 through 6 are to be assembled to a primitive.

Thus, while performing the second rendering pipeline, the rendering apparatus may search for the domain visibility stream 675 matching each input patch by using the input patch stream 635.

In the second rendering pipeline, the second tessellation 650b may include generating domain information of a domain indicated to be visible by the domain visibility stream 675 matching an input patch, and the second domain shading 660b may be performed only on the indicated visible domains based on the domain information. In addition, the second primitive assembly 670b may be performed on vertices resulting from the second domain shading 660b, by using the primitive assembly stream 690.

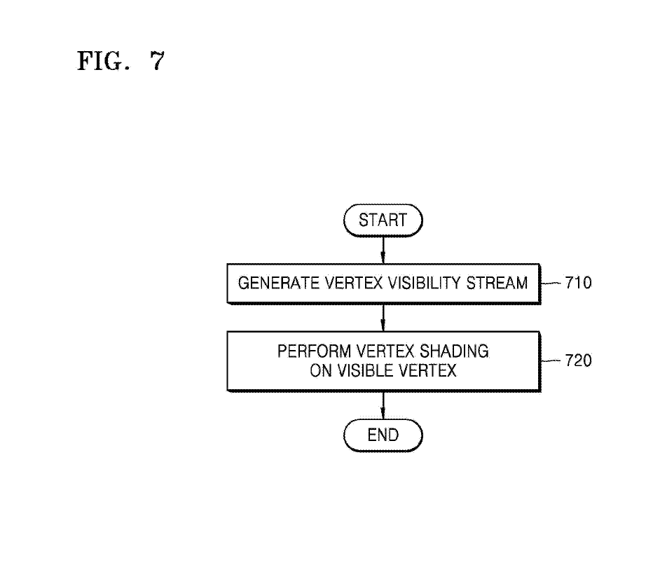

FIG. 7 is a flowchart of a method of performing selective vertex shading, according to one or more embodiments.

In operation 710, the rendering apparatus may generate a vertex visibility stream indicating whether at least one vertex will be visible during rendering. As only an example, the vertices may be vertices of predetermined primitives of an input patch, or the vertices may be control points that define a surface of the patch.

The rendering apparatus may obtain the vertex visibility stream by performing a first rendering pipeline. The rendering apparatus may obtain the vertex visibility stream by performing the first rendering pipeline using respective location information about each vertex. In an embodiment, the rending apparatus may perform the first rendering pipeline using only location information about the vertex, or only information required to generate the vertex visibility stream.

The rendering apparatus according to an embodiment may generate the vertex visibility stream indicating whether each vertex is visible, based on a depth test performed on each vertex.

The rendering apparatus according to an embodiment may additionally generate a primitive assembly stream indicating whether vertices are to be assembled to a primitive, e.g., based on whether the depth test indicates that the corresponding primitive is a visible primitive.

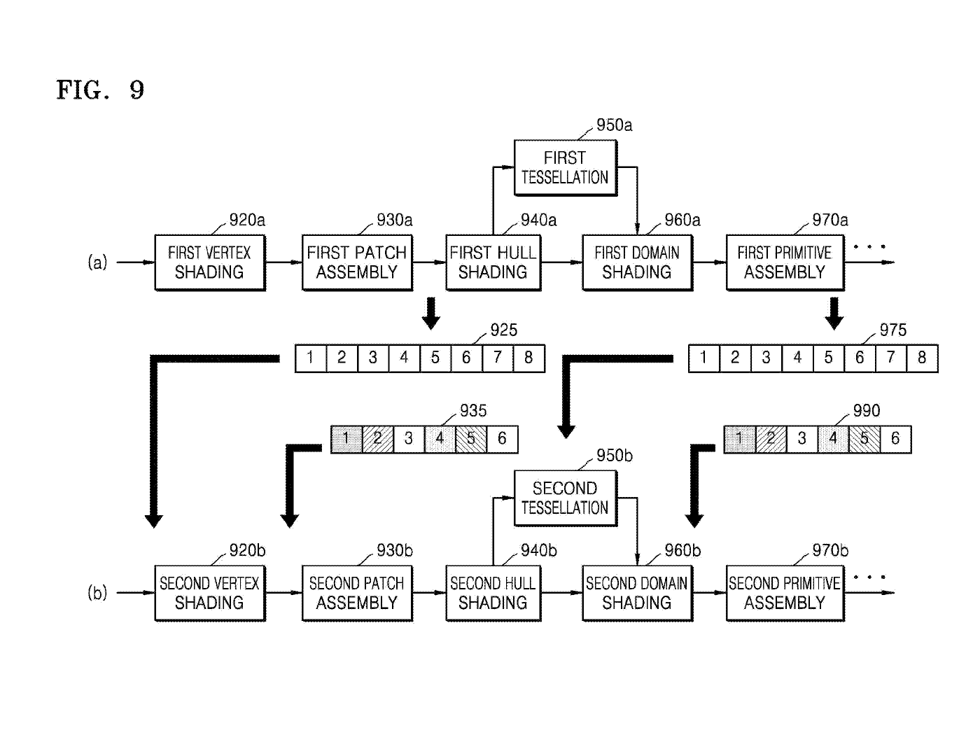

As only an example, when a tessellator stage and a vertex shader of such a rendering apparatus operate together, the vertex shader may perform a function of managing an input patch. In the first rendering pipeline, the rendering apparatus may generate a control point visibility stream indicating whether at least one control point of the input patch is visible during rendering. The rendering apparatus may additionally generate a patch assembly stream indicating whether control points are assembled to a patch, indicating whether each patch is to be assembled based on whether the corresponding control points representing that patch are visible, as discussed below regarding FIG. 9. Herein, as only an example, control points may be points that define a geometric surface represented by the patch. For example, such a surface may be defined by a polynomial formula, where a moving of one or more of the control points may have an effect on the entire surface. Thus, as only an example, surfaces or curves of the patch may be defined using such a set of control points, which may also be represented herein as vertices of the patch.

In operation 720, in a second rendering pipeline, the rendering apparatus may perform vertex shading on a visible vertex based on vertex information about the visible vertex based on the vertex visibility stream.

The second rendering pipeline may be a rendering process for displaying a scene on an actual screen of a display, for example, and typically processes more information than the first rendering pipeline performed in operation 710, e.g., unless most or all respective domains are found to be invisible in the first rendering pipeline. However, since the rendering apparatus may skip rendering processes for invisible vertices during such an actual rendering, an overhead may be reduced. As only an example, such an actual rendering may include vertex shading only in the second rendering pipeline, where vertex shading may be skipped for invisible vertices.

Thus, this skipping of rendering processes for invisible vertices reduces unnecessary operations and memory use, compared to a single rendering pipeline operation where rendering operations, such as vertex shading, are performed on all vertices.

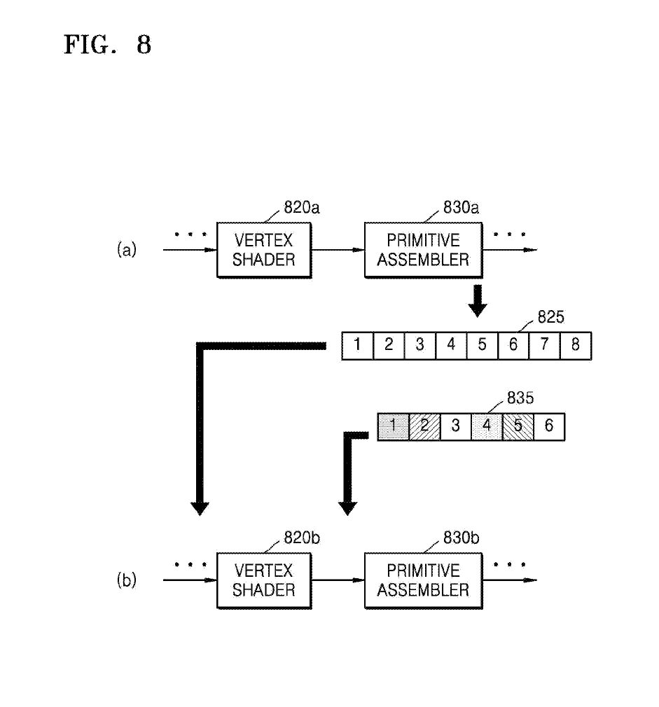

As will be discussed below with FIG. 8, the rendering apparatus according to an embodiment may perform primitive assembly on vertices obtained as a result of the vertex shading, by using the primitive assembly stream.

FIG. 8 is a diagram describing a method of performing selective vertex shading, such as the method of performing selective vertex shading of FIG. 7, according to one or more embodiments.

In FIG. 8, a rendering pipeline may not include a tessellator stage. For example, the rendering pipeline may not include a hull shader, tesselator, and domain shader, as discussed above. Alternatively, in the embodiment of FIG. 8, the rendering pipeline may include the tessellator stage but the tessellator stage may be controlled to not operate, e.g., so that primitive assembler is provided the vertices generated by the vertex shader.

Thus, FIG. 8 illustrates a 2-pass rendering pipeline. Illustration (a) of FIG. 8 demonstrates a first rendering pipeline for generating a vertex visibility stream 825, and illustration (b) of FIG. 8 demonstrates a second rendering pipeline for actual rendering, for example, which performs a rendering process on a visible vertex based on the vertex visibility stream 825. The vertex visibility stream 825 may include information indicating that vertices having IDs of 1 through 8 are visible. Here, these referred to vertices are vertices of an input patch or an input primitive.

The rendering apparatus according to an embodiment may determine whether a vertex of a primitive or a patch input to a vertex shader 820 will be visible during rendering, while performing the first rendering pipeline. The rendering apparatus may generate the vertex visibility stream 825 based on the determination of whether each vertex will be visible during rendering.

The rendering apparatus according to an embodiment may additionally generate a primitive assembly stream 835 indicating whether such vertices are to be assembled to a primitive or patch. For example, the primitive assembly stream 835 may indicate whether an entire assembled primitive or patch would be visible. For example, the primitive assembly stream 835 may include information indicating whether vertices, i.e., having IDs of 1 through 8 in the vertex visibility stream 825, are assembled to primitives, with the primitives of the primitive assembly stream 835 having IDs of 1 through 6. As a result, the primitive assembly stream 835 may indicate visibility of each primitive. The first rendering pipeline may be performed by using information required to generate the vertex visibility stream 825 and the primitive assembly stream 835, and in an embodiment the first rendering pipeline may be performed by using only information required to generate the vertex visibility stream 825 and the primitive assembly stream 835. The information required to generate the vertex visibility stream 825 and the primitive assembly stream 835 may include, for example, location information about a vertex of an input patch and depth information for a corresponding scene, as only an example.

In the rendering apparatus, during a second rendering pipeline, a vertex shader 820b may use the generated vertex visibility stream 825 to perform a rendering process on a visible vertex of the corresponding patch.

While performing the second rendering pipeline, the vertex shader 820b may perform a rendering process only on a vertex that is indicated to be visible by the vertex visibility stream 825, by using the vertex visibility stream 825 that matches an input patch or input primitive to be processed. Also, a primitive assembler 830b may assemble output vertices of the vertex shader 820b to a primitive by using the primitive assembly stream 835.

Here, the vertex shader 820a and vertex shader 820b may be the same vertex shader, and the primitive assembler 830a and primitive assembler 830b may be the same primitive assembler, respectively implementing first and second rendering pipeline operations. Alternatively, the vertex shader 820a and the primitive assembler 830a may be different from the vertex shader 820b and the primitive assembler 830b.

FIG. 9 is a diagram describing a method of performing selective vertex shading, such as the method of performing selective vertex shading of FIG. 7, according to one or more embodiments.

In FIG. 9, a tessellator stage of each rendering pipeline exists or is controlled to operate. When the tessellator stage of the rendering pipeline operates, a vertex shader may perform a function of managing an input patch, for example.

Descriptions overlapping those of FIG. 6 are not provided again in FIG. 9. In detail, first and second hull shading 940a and 940b, first and second tessellation 950a and 950b, first and second domain shading 960a and 960b, and first and second primitive assembly 970a and 970b of FIG. 9 respectively correspond to the first and second hull shading 640a and 640b, the first and second tessellation 650a and 650b, the first and second domain shading 660a and 660b, and the first and second primitive assembly 670a and 670b of FIG. 6, and thus details thereof are not provided again.

FIG. 9 illustrates a 2-pass rendering pipeline. Illustration (a) of FIG. 9 demonstrates a first rendering pipeline for generating a control point visibility stream 925, a patch assembly stream 935, a domain visibility stream 975, and a primitive assembly stream 990. The control point visibility stream 925 may indicate whether each of at least one control point included in an input patch is visible during rendering.

Illustration (b) of FIG. 9 demonstrates a second rendering pipeline for actual rendering, for example, which performs a rendering process on a visible control point by using the control point visibility stream 925. The control point visibility stream 925 may include information indicating whether control points having IDs of 1 through 8, included in the input patch, are visible.

First and second vertex shading 920a and 920b may be performed on each control point of an input patch. During the first and second vertex shading 920a and 920b, a 3D location of each control point in a virtual space may be converted to a 2D coordinate and depth value, e.g., for representing the 2D object as having three dimensions on a screen. This depth value may also be used for implementing the aforementioned visibility depth tests. In an embodiment, during the first and second vertex shading 920a and 920b, features, such as a location, a color, and a texture coordinate, may be adjusted, but a new control point may not generated.

The rendering apparatus according to an embodiment may determine whether a control point of a patch input during the first vertex shading 920a is visible while performing the first rendering pipeline. The rendering apparatus may generate the control point visibility stream 925 based on whether each control point is determined to be visible during rendering.

The rendering apparatus according to an embodiment may additionally generate the patch assembly stream 935 indicating whether control points are assembled to a patch. The patch assembly stream 935 may include information indicating whether control points are assembled to patches having IDs of 1 through 6. As a result, the patch assembly stream 935 may indicate the visibility of each patch. The first rendering pipeline may be performed by using information required to generate the control point visibility stream 925 and the patch assembly stream 935, and in an embodiment the first rendering pipeline for the vertex shading may be performed by only using information required to generate the control point visibility stream 925, the patch assembly stream 935, the domain visibility stream 975, and the primitive assembly stream 990. The information required to generate the control point visibility stream 925 and the patch assembly stream 935 may include, for example, location information of the control points.

In the second rendering pipeline, the rendering apparatus may perform the second vertex shading 920b on a visible control point based on the generated control point visibility stream 925.

While performing the second rendering pipeline, the second vertex shading 920b may be performed only on a control point indicated to be visible by the control point visibility stream 925, based on the control point visibility stream 925 that matches an input patch to be processed. In addition, second patch assembly 930b may be performed on control points output during the second vertex shading 920b, by using the patch assembly stream 935 to assemble the control points to a patch.

As such, the rendering apparatus according to an embodiment may perform vertex shading only on visible control points based on the control point visibility stream 925. In addition, the rendering apparatus may perform patch assembly by only using information about control points assembled to a patch, based on the patch assembly stream 935. Accordingly, the rendering apparatus according to an embodiment may reduce throughput while performing rendering through a rendering pipeline, thereby reducing unnecessary power consumption.

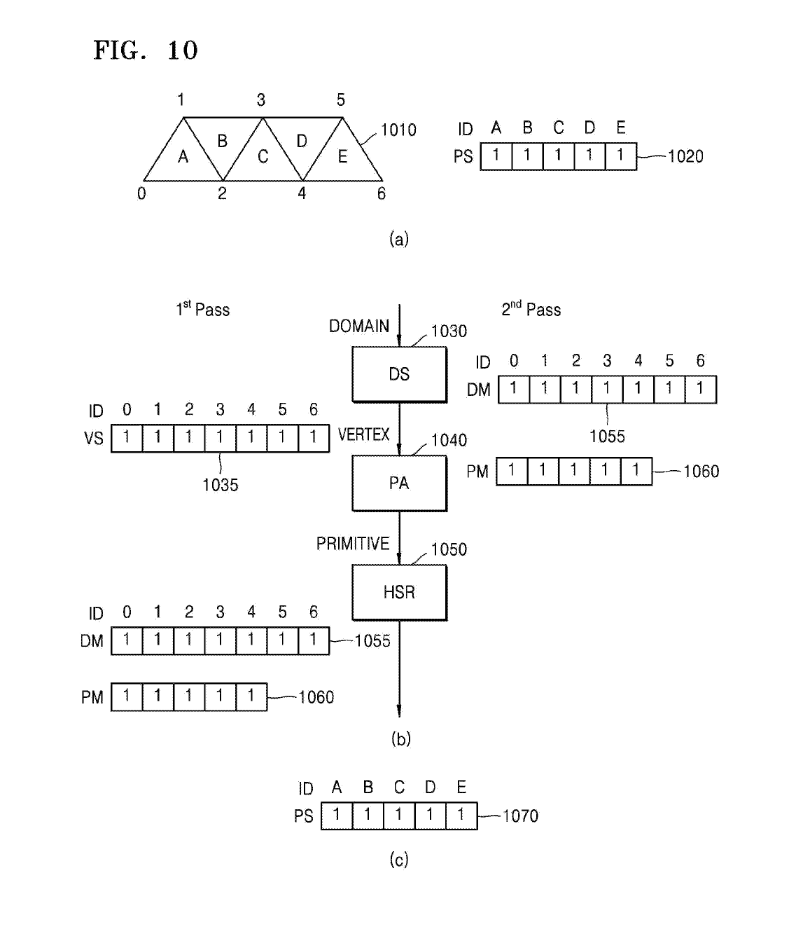

FIGS. 10 through 13 are diagrams describing example generations of domain visibility streams (DMs) 1055, 1155, 1255, and 1355 and primitive assembly streams (PMs) 1060, 1160, 1260, and 1360, according to one or more embodiments.

Referring to illustrations (a) of FIGS. 10 through 13, primitive streams (PSs) 1020, 1120, 1220, and 1320 may indicate the visibility of each primitive derived from the identified input patches 1010, 1110, 1210, and 1310. Identifiers A through F of the primitive streams 1020 through 1320 represent IDs of primitives formed from the input patch. In the primitive streams 1020 through 1320, “1” denotes that a primitive is visible and “0” denotes that a primitive is invisible.

In illustrations (b) of FIGS. 10 through 13, domains for the input patches 1010 through 1310 are output as vertices via domain shading (DS) 1030, 1130, 1230, and 1330, the vertices are output as primitives via primitive assembly (PS) 1040, 1140, 1240, and 1340, and hidden surface removal (HSR) processes 1050, 1150, 1250, and 1350 are performed on the primitives. Referring to the illustrated left portions of illustrations (b) of FIGS. 10 through 13, the domain visibility streams 1055 through 1355 and the primitive assembly streams 1060 through 1360 are generated as a first rendering pipeline is performed, illustrated as the “1^{st} Pass”. As illustrated, vertex streams (VSs) 1035, 1135, 1235, and 1335 may include the respective domain shading results of the domain shading 1030 through 1330 on the domains for the respective input patches 1010 through 1310.

The primitive assembly streams 1060 through 1360 according to an embodiment may include an ID of a domain that is first displayed in the domain visibility streams 1055 through 1355 from among domains used to assemble each primitive. Here, when the domain that is first displayed in the domain visibility streams 1055 through 1355, from among the domains used to assemble each primitive, is invisible, such a primitive may be excluded from the primitive assembly streams 1060 through 1360.

Referring to the illustrated right portions of illustrations (b) of FIGS. 10 through 13, the rendering apparatus performs the second rendering pipeline, illustrated as the “2^{nd} Pass”, with the domain shading 1030 through 1330 using the domain visibility streams 1055 through 1355 generated in the first rendering pipeline, and the primitive assembly 1040 through 1340 using the primitive assembly streams 1060 through 1360 generated in the first rendering pipeline.

Referring to illustrations (c) of FIGS. 10 through 13, streams 1070, 1170, 1270, and 1370 of visible primitives are shown with IDs. In other words, the rendering apparatus according to one or more embodiments may skip a rendering process for invisible primitives, e.g., so as to perform such a rendering process only on visible primitives.

FIGS. 10 through 13 will now be described in more detail.

Illustration (a) of FIG. 10 demonstrates the input patch 1010 and a demonstrative primitive stream 1020. Here, based on tessellation partitioning or division, domains having IDs of 0 through 6 and primitives having IDs of A through E are represented for the input patch 1010.

Referring to illustration (b) of FIG. 10, the vertex stream 1035 may represent domain shaded vertices for the input patch 1010 by respective IDs of 0 through 6. Here, since the domains having IDs of 0 through 6 for the input patch 1010 are visible, bits corresponding to IDs 0 through 6 in the domain visibility stream 1055 may have a value of 1 to indicate that the domains are visible. Similarly, since the primitives having IDs of A through E for the input patch 1010 are visible, bits corresponding to IDs A through E in the primitive assembly stream 1060 may have a value of 1 to indicate that the primitives may be assembled because they are visible.

Referring to the primitive assembly stream 1060, a first bit represents a primitive assembled by using the domains having IDs of 0 through 2, a second bit represents a primitive assembled by using the domains having IDs of 1 through 3, a third bit represents a primitive assembled by using the domains having IDs of 2 through 4, a fourth bit represents a primitive assembled by using the domains having IDs of 3 through 5, and a fifth bit represents a primitive assembled by using domains having IDs of 4 through 6. Here, since all primitives are assembled, e.g., because all primitives are visible, all bits of the primitive assembly stream 1060 have a value of 1. Here, in the example of FIGS. 10-13, the referred to domains that have IDs 0-6 may be considered domain vertices, e.g., vertices output by a tessellator toward the corresponding domain shader, for example.

Referring to the domain visibility stream 1055, because all domains are visible during rendering, the rendering apparatus generates domain information about the all domains and performs the domain shading 1030. In addition, referring to the primitive assembly stream 1060, because all primitives are assembled, the primitive assembly 1040 may be performed on the all primitives, resulting in stream 1070.

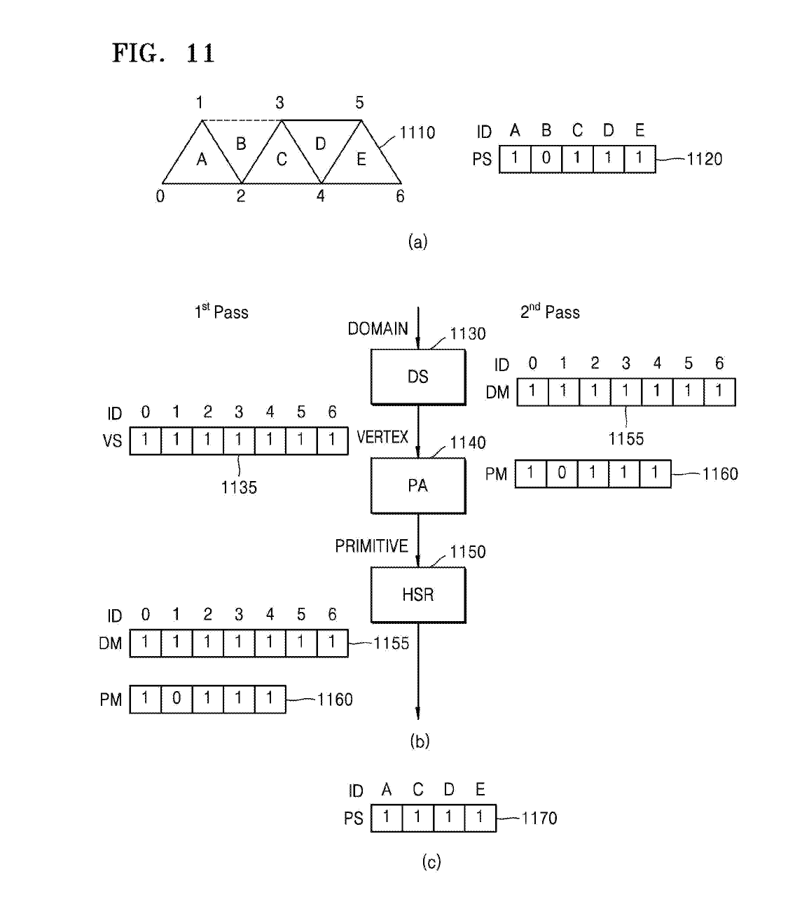

Illustration (a) of FIG. 11 demonstrates the input patch 1110 and a demonstrative primitive stream 1120. Here, based on tessellation partitioning or division, domains having IDs of 0 through 6 and primitives having IDs of A through E are represented for the input patch 1110.

Referring to illustration (b) of FIG. 11, the vertex stream 1135 may represent domain shaded vertices for the input patch 1110 by respective IDs of 0 through 6. Here, since the domains having IDs of 0 through 6 for the input patch 1110 are visible, bits corresponding to IDs 0 through 6 in the domain visibility stream 1155 may have a value of 1 to indicate that the domains are visible. In addition, since the primitives having IDs of A, C, D, and E for the input patch 1110 are visible and the primitive having ID of B is invisible, bits corresponding to only IDs A, C, D, and E in the primitive assembly stream 1160 may have a value of 1 to indicate that the primitives may be assembled. The bit corresponding to the ID of B may have a value of 0 to indicate that the primitive may not be assembled.

Referring to the primitive assembly stream 1160 of FIG. 11, a first bit represents a primitive assembled by using the domains having IDs of 0 through 2, a second bit represents a primitive assembled by using the domains having IDs of 1 through 3, a third bit represents a primitive assembled by using the domains having IDs of 2 through 4, a fourth bit represents a primitive assembled by using the domains having IDs of 3 through 5, and a fifth bit represents a primitive assembled by using domains having IDs of 4 through 6. Here, since the primitive having the ID of B is not assembled, the second bit of the primitive assembly stream 1160 corresponding to the primitive having ID of B may have a value of 0 and the remaining bits of the primitive assembly stream 1160 corresponding to other primitives having IDs of A, C, D, and E may have a value of 1.

Referring to the domain visibility stream 1155, all domains are visible during rendering. Thus, the rendering apparatus generates domain information about the all domains and performs the domain shading 1130 for all domains. In addition, referring to the primitive assembly stream 1160, since only the primitives having IDs of A, C, D, and E are assembled, the primitive assembly 1140 may be performed only on the primitives having IDs of A, C, D, and E, which have a value of 1, resulting in stream 1170.

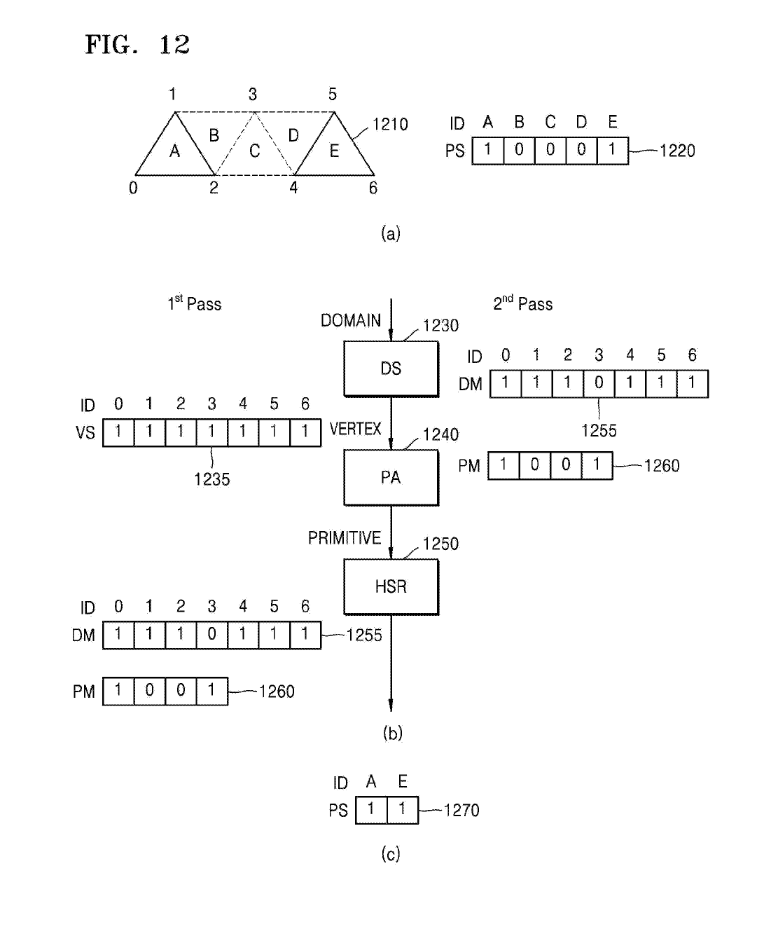

Illustration (a) of FIG. 12 demonstrates the input patch 1210 and a demonstrative primitive stream 1220. Here, based on tessellation partitioning or division, domains having IDs of 0 through 6 and primitives having IDs of A through E are represented for the input patch 1210.

Referring to illustration (b) of FIG. 12, the vertex stream 1235 may represent domain shaded vertices for the input patch 1210 by respective IDs of 0 through 6. Here, since the domains having IDs of 0 through 2 and 4 through 6 for the input patch 1210 are visible, only bits corresponding to IDs 0 through 2 and 4 through 6 in the domain visibility stream 1255 may have a value of 1 to indicate that the domains are visible.

In addition, since the primitives having IDs of A and E for the input patch 1210 are visible and the primitives having IDs of B through D are invisible, only bits corresponding to IDs A and E may have a value of 1 to indicate that the primitives are visible. Referring to the primitive assembly stream 1260, a first bit represents a primitive assembled by using the domains having IDs of 0 through 2, a second bit represents a primitive assembled by using the domains having IDs of 1 through 3, and a third bit represents a primitive assembled by using the domains having IDs of 2 through 4. Since the domain having an ID of 3 is invisible, the primitive having ID of D assembled by using the domains having IDs of 3 through 5 may be excluded from the primitive assembly stream 1260. Accordingly, the fourth bit of the primitive assembly stream 1260 represents a primitive assembled by using the domains having IDs of 4 through 6. Here, since the primitives having IDs of B and C, represented by the second and third bits of the primitive assembly stream 1260, are not assembled, these bits corresponding to the primitives having IDs of B and C may have a value of 0 and bits of the primitive assembly stream 1260 corresponding to the primitives having IDs of A and E may have a value of 1.

Referring to the domain visibility stream 1255, domains having IDs of 0 through 2 and 4 through 6 are visible during rendering. Thus, the rendering apparatus generates domain information about the domains having IDs of 0 through 2 and 4 through 6 and performs the domain shading 1230 on the domains having IDs of 0 through 2 and 4 through 6. In addition, referring to the primitive assembly stream 1260, since only the primitives having IDs of A and E are assembled, the primitive assembly 1240 may be performed only on the primitives having IDs of A and E, which have a value of 1, resulting in stream 1270.

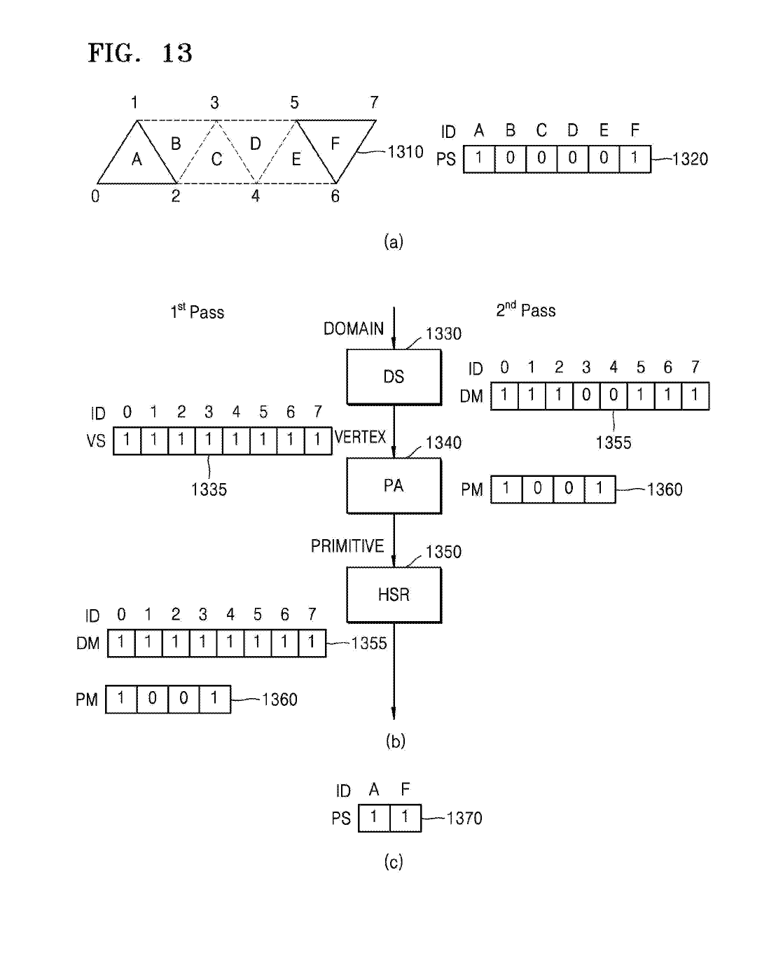

Illustration (a) of FIG. 13 demonstrates the input patch 1310 and a demonstrative primitive stream 1320. Here, based on tessellation partitioning or division, domains having IDs of 0 through 7 and primitives having IDs of A through F are represented for input patch 1310.

Referring to illustration (b) of FIG. 13, the vertex stream 1335 may represent domain shaded vertices for the input patch 1310 by respective IDs of 0 through 7. Since the domains having IDs of 0 through 2 and 5 through 7 for the input patch 1310 are visible, only bits corresponding to IDs 0 through 2 and 5 through 7 in the domain visibility stream 1355 may have a value of 1 to indicate that the domains are visible.

In addition, since the primitives having IDs of A and F for the input patch 1310 are visible and the primitives having IDs of B through E are invisible, only bits corresponding to IDs A and F may have a value of 1 to indicate that the primitives are visible. Referring to the primitive assembly stream 1360, a first bit represents a primitive assembled by using the domains having IDs of 0 through 2, a second bit represents a primitive assembled by using the domains having IDs of 1 through 3, and a third bit represents a primitive assembled by using the domains having IDs of 2 through 4. Since the domain having an ID of 3 is invisible, the primitive having ID of D assembled by using the domains having IDs of 3 through 5 may be excluded from the primitive assembly stream 1360. In addition, since the domain having ID of 4 is invisible, the primitive having ID of E assembled by using the domains having IDs of 4 through 6 may be excluded from the primitive assembly stream 1360. Accordingly, the fourth bit of the primitive assembly stream 1360 represents the primitive having ID of F assembled by using the domains having IDs of 5 through 7. Here, since the primitives having IDs of B and C, represented by the second and third bits of the primitive assembly stream 1360, are not assembled, these bits corresponding to the primitives having IDs of B and C may have a value of 0 and bits of the primitive assembly stream 1360 corresponding to other primitives having IDs of A, D through F may have a value of 1.

Referring to the domain visibility stream 1355, the domains having IDs of 0 through 2 and 5 through 7 are visible during rendering. Thus, the rendering apparatus generates domain information about the domains having IDs of 0 through 2 and 5 through 7 and performs the domain shading 1330 on the domains having IDs of 0 through 2 and 5 through 7. In addition, referring to the primitive assembly stream 1360, since only the primitives having IDs of A and F are assembled, the primitive assembly 1340 may be performed only on the primitives having IDs of A and F, which have a value of 1, resulting in stream 1370.

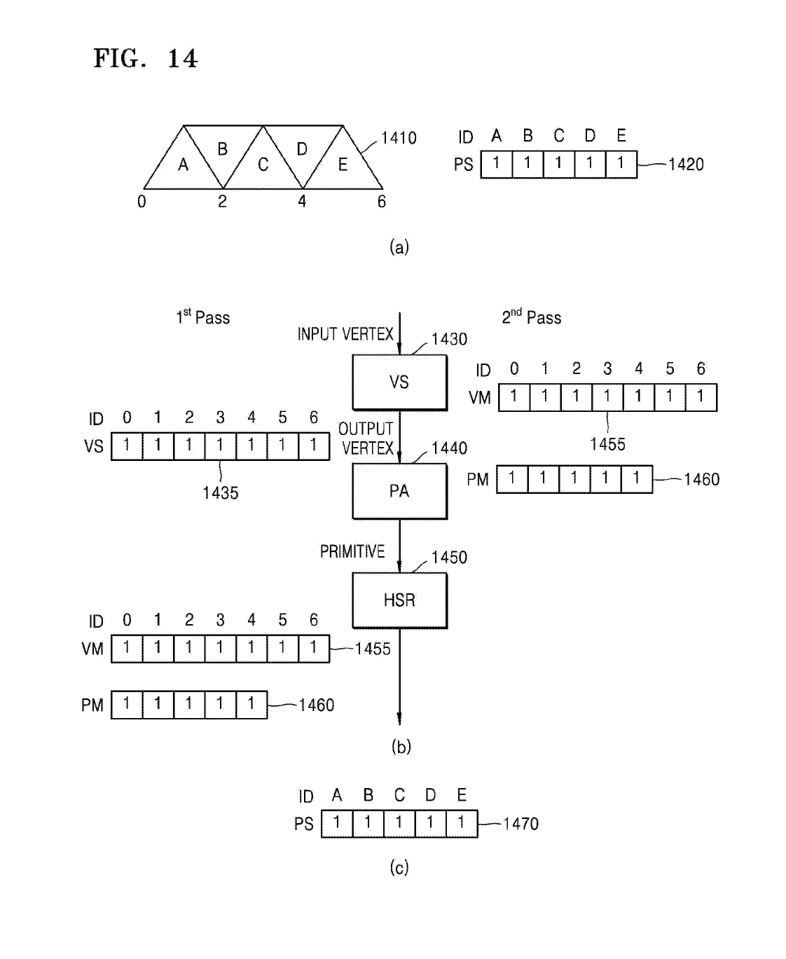

FIG. 14 is a diagram describing a generating of a vertex visibility stream 1455 and a primitive assembly stream 1460, according to one or more embodiments.

Illustration (a) of FIG. 14 demonstrates an input patch 1410 and a corresponding primitive stream 1420. Here, the input patch 1410 may alternatively be an input primitive with the example predefined vertices. Continuing with the example of the input patch 1410, the input patch 1410 may include predetermined primitives that have IDs of A through E and whose known vertices have IDs of 0 through 6. Alternatively, in an embodiment, the vertices may be based on control points of the input patch 1410. The primitive stream 1420 may indicate visibility of each of the primitives forming the input patch 1410. Here, a bit value of 1 indicates that a primitive is visible and a bit value of 0 indicates that a primitive is invisible.

In illustration (b) of FIG. 14, input vertices are output as output vertices via vertex shading 1430, the output vertices are output as primitives via primitive assembly 1440, and HSR processing 1450 is performed on the primitives.

Referring to illustration (b) of FIG. 14, the vertex visibility stream 1455 and the primitive assembly stream 1460 are generated when a first rendering pipeline is performed. A vertex stream 1435 may be generated as the vertex shading 1430 is performed on the input vertices. The vertex stream 1435 may represent these vertices included in the input patch 1410 by respective IDs of 0 through 6. Since the vertices having IDs of 0 through 6 included in the input patch 1410 are visible, bits having IDs of 0 through 6 in the vertex visibility stream 1455 may have a value of 1 to indicate that the vertices are visible. In addition, since primitives having IDs of A through E included in the input patch 1410 are visible, bits corresponding to the IDs A through E in the primitive assembly stream 1460 may have a value of 1 to indicate that the primitives may be assembled.

The primitive assembly stream 1460 according to an embodiment may include an ID of a vertex that is first displayed in the vertex visibility stream 1455, from among vertices used to assemble each primitive. For example, a first bit of the primitive assembly stream 1460 represents a primitive assembled by using vertices having IDs of 0 through 2, a second bit represents a primitive assembled by using vertices having IDs of 1 through 3, a third bit represents a primitive assembled by using vertices having IDs of 2 through 4, a fourth bit represents a primitive assembled by using vertices having IDs of 3 through 5, and a fifth bit represents a primitive assembled by using vertices having IDs of 4 through 6. Here, since all primitives are assembled, all bits of the primitive assembly stream 1460 have a value of 1.

The rendering apparatus may perform the vertex shading 1430 by using the vertex visibility stream 1455 and perform the primitive assembly 1440 by using the primitive assembly stream 1460. Referring to the vertex visibility stream 1455, since all vertices are visible during rendering, the rendering apparatus performs the vertex shading 1430 in the second rendering pipeline by using vertex information about the all vertices. In addition, referring to the primitive assembly stream 1460, since all primitives are assembled, the primitive assembly 1440 may be performed on the all primitives.

Referring to illustration (c) of FIG. 14, a stream 1470 of visible primitives is shown with IDs. Accordingly, in an embodiment, a rendering apparatus according to an embodiment may perform a rendering process, such as vertex shading, only on visible primitives and skip such a rendering process on an invisible primitive.

FIG. 15 is a block diagram of a rendering apparatus, according to multiple embodiments. In one or more embodiments, one or more of the above embodiments may be implemented by the rendering apparatus 1500 of FIG. 15. Accordingly, for simplicity of explanation, the above descriptions are not repeated below, but the same should be considered equally applicable and available for the rendering apparatus 1500 of FIG. 15.

As shown in FIG. 15, the rendering apparatus 1500 may include a first rendering pipeline performer 1510 and a second rendering pipeline performer 1520, for example. Here, the pipeline performers are illustrated as separate pipeline performers for explanation purposes to demonstrate examples of the sequencing of the first and second pipeline operations and is not intended to limit the rendering apparatus to have separate pipeline devices, such as separate GPUs or separate GPU cores.

Rather, in an embodiment, the first rendering pipeline performer 1510 and the second rendering pipeline performer 1520 represent a particular GPU or GPU core and represent sequenced performances of the particular GPU or GPU core. For example, the particular GPU or GPU core may include a first vertex shader, a first hull shader, a first tessellator, and a first domain shader. The particular GPU of GPU core may further include a first patch assembler, first primitive assembler, and/or first hidden surface removal element. Here, the first vertex shader may sequentially perform, if any, a first vertex shading as the first rendering pipeline performer 1510 and a second vertex shading as the second rendering pipeline performer 1520. Likewise, in this example, the first hull shader may sequentially perform a first hull shading as the first rendering pipeline performer 1510 and a second hull shading as the second rendering pipeline performer 1520, the first tessellator may sequentially perform a first tessellation as the first rendering pipeline performer 1510 and a second tessellation as the second rendering pipeline performer 1520, the first domain shader may sequentially perform, if any, a first domain shading as the first rendering pipeline performer 1510 and a second domain shading as the second rendering pipeline performer 1520, and the first primitive assembler may sequentially perform a first primitive assembly as the first rendering pipeline performer 1510 and a second primitive assembly as the second rendering pipeline performer 1520, as only examples.

Alternatively, in an embodiment, the first rendering pipeline performer 1510 is a first GPU or GPU core and the second rendering pipeline performer 1520 is a separate second GPU or GPU core. In this example, the first GPU or GPU core may include the first vertex shader to perform the first vertex shading, the first hull shader to perform the first hull shading, the first tessellator to perform the first tessellation, and the first domain shader to perform the first domain shading, while the second GPU or GPU core may include a second vertex shader to perform the second vertex shading, a second hull shader to perform the second hull shading, a second tessellator to perform the second tessellation, and a second domain shader to perform the second shading. Likewise, the first GPU or GPU core may further include the first patch assembler to perform a first patch assembly, the first primitive assembler to perform the first primitive assembly, and/or the first hidden surface removal element to perform a first hidden surface removal, while the second GPU or GPU core may include a second patch assembler to perform a second patch assembly, a second primitive assembler to perform a second primitive assembly, and/or a second hidden surface removal element to perform a second hidden surface removal. The first vertex shader may perform, if any, the first vertex shading of one or more input patches before the second vertex shader performs the second vertex shading for the input patches. Similarly, the first hull shader may perform the first hull shading before the second hull shader performs the second hull shading, the first tessellator may perform the first tessellation before the second tessellator performs the second tesselation, the first domain shader may perform, if any, the first domain shading before the second domain shader performs the second domain shading, and the first primitive assembler may perform the first primitive assembly before the second primitive assembler performs the second primitive assembly, as only examples. In an embodiment, the first tessellation or both the first tessellation and any first domain shading are performed before the second vertex shading, second hull shading, or second tessellation.

In addition, in one or more embodiments, these example GPU or GPU core(s) may be configured as discussed above with regard to FIGS. 7, 8, and 14 and either selectively not operate or not include tessellation stage(s), as only examples. Likewise, in one or more embodiments, these example GPU or GPU core(s) may be configured as discussed above with regard to FIGS. 1-6 and 9-13, as only examples. In addition, though references have been made to embodiments being implemented by GPU or GPU core(s), embodiments are not limited thereto, and such references also refer to other one or more computational processing devices, processors, or computers.

Accordingly, herein, unless specifically set forth otherwise, such as when the first rendering pipeline performer 1510 and the second rendering pipeline performer 1520 are separate GPU or GPU cores, a referred to first pipeline represented by the first rendering pipeline performer 1510 and a second pipeline represented by the second rendering pipeline performer 1520 may be such different pipeline hardware or the same pipeline hardware, e.g., the example GPU or GPU core, operated according to a particular sequence.

In view of the above, the first rendering pipeline performer 1510 and the second rendering pipeline performer 1520 will now be more particularly discussed.

The first rendering pipeline performer 1510 may generate a domain visibility stream indicating whether at least one domain for an input patch is visible during rendering.

The first rendering pipeline performer 1510 according to an embodiment may generate the domain visibility stream by performing a rendering pipeline, such as including a tessellation stage to generate one or more domains for the input patch, using location information about a vertex of the input patch. For example, the first rendering pipeline performer 1510 may generate the domain visibility stream indicating whether the domains for the input patch are visible during rendering, e.g., based on a depth test performed on each of the domains.

The first rendering pipeline performer 1510 according to an embodiment may generate a vertex visibility stream indicating whether at least one vertex is visible during rendering.

The first rendering pipeline performer 1510 according to an embodiment may generate a primitive assembly stream indicating whether domains or vertices are assembled to a primitive.

The first rendering pipeline performer 1510 according to an embodiment may, when a tessellator operates, generate a control point visibility stream indicating whether at least one control point input to a vertex shader is visible during rendering. In addition, the first rendering pipeline performer 1510 may generate a patch assembly stream indicating whether control points are assembled to a patch.

The second rendering pipeline performer 1520 may generate domain information about a respective region of the input patch by using the domain visibility stream generated by the first rendering pipeline 1510, and perform domain shading on a visible domain based on the domain information. As only an example, each domain may represent a different partitioned or divided region of the input patch or represent vertices of such regions.

The second rendering pipeline 1520 according to an embodiment may skip domain shading on a domain indicated to be invisible by the domain visibility stream generated by the first rendering pipeline 1510.

The second rendering pipeline performer 1520 according to an embodiment may perform vertex shading on a visible vertex based on vertex information about the visible vertex, by using the vertex visibility stream generated by the first rendering pipeline 1510.

The second rendering pipeline performer 1520 according to an embodiment may perform primitive assembly by using the primitive assembly stream generated by the first rendering pipeline 1510. For example, the second rendering pipeline performer 1520 may perform the primitive assembly on vertices obtained as a result of performing the domain shading. Alternatively, the second rendering pipeline performer 1520 may perform the primitive assembly on vertices obtained as a result of performing the vertex shading.

The second rendering pipeline performer 1520 according to an embodiment may perform vertex shading on a visible control point by using the control point visibility stream generated by the first rendering pipeline 1510. In addition, the second rendering pipeline performer 1520 may perform patch assembly by using the patch assembly stream generated by the first rendering pipeline 1510.

The rendering apparatus 1500 according to an embodiment may selectively perform tessellation stage operations based on visibility information. For example, throughput of a tessellator and throughput of a domain shader, both of the tessellation stage, may be reduced when performing the second rendering pipeline 1520. As a result, memory use and power consumption may be reduced.

The rendering apparatus 1500 according to an embodiment may selectively perform vertex shading operations based on visibility information, thereby reducing throughput of a vertex shader while performing the second rendering pipeline 1520. As a result, memory use and power consumption may be reduced.

As described above, in a method of performing selective tessellation stage operations according to one or more embodiments, unnecessary operations may be reduced when performing tessellation.

In addition, in a method of performing selective vertex shading according to one or more embodiments, unnecessary operations may be reduced when performing vertex shading.

An electronic device embodiment, e.g., implementing one or more of the above embodiments, may include a processor, a memory for storing program data and executing it, a permanent storage such as a disk drive, a communications port for handling communications with external devices, and user interface devices, including a display, keys, etc., and may be configured to display rendered primitives on the display based on one or more of the above embodiments regarding selective tessellation stage operation and/or vertex shading, as only examples.

In addition, apparatuses, units, modules, devices, and other components illustrated in FIGS. 1, 8, and 15, for example, that may perform operations described herein with respect to FIGS. 2-7 and 9-14, for example, are implemented by hardware components. Examples of hardware components include controllers, sensors, memory, drivers, and any other electronic components known to one of ordinary skill in the art. In one example, the hardware components are implemented by one or more processing devices, or processors, or computers. A processing device, processor, or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processing device, processor, or computer includes, or is connected to, one or more memories storing computer readable code, instructions, or software that are executed by the processing device, processor, or computer and that may control the processing device, processor, or computer to implement one or more methods described herein. Hardware components implemented by a processing device, processor, or computer execute code, instructions, or software, such as an operating system (OS) and one or more software applications that run on the OS, to perform the operations described herein with respect to FIGS. 2-7 and 9-14, as only an example. The hardware components also access, manipulate, process, create, and store data in response to execution of the instructions or software. For simplicity, the singular term “processing device”, “processor”, or “computer” may be used in the description of the examples described herein, but in other examples multiple processing devices, processors, or computers are used, or a processing device, processor, or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, remote processing environments, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2-7 and 9-14 that perform the operations described herein may be performed by a processing device, processor, or a computer as described above executing processor or computer readable code, instructions, or software to perform the operations described herein.

Processor or computer readable code, instructions, or software to control a processing device, processor, or computer to implement the hardware components and perform the methods as described above may be written as computer programs, code segments, instructions or any combination thereof, for individually or collectively instructing or configuring the processing device, processor, or computer to operate as a machine or special-purpose computer to perform the operations performed by the hardware components and the methods as described above. In one example, the processor or computer readable code, instructions, or software include machine code that is directly executed by the processing device, processor, or computer, such as machine code produced by a compiler. In another example, the processor or computer readable code, instructions, or software include higher-level code that is executed by the processing device, processor, or computer using an interpreter. Based on the disclosure herein, and after an understanding of the same, programmers of ordinary skill in the art can readily write the processor or computer readable code, instructions, or software based on the block diagrams and the flow charts illustrated in the drawings and the corresponding descriptions in the specification, which disclose algorithms for performing the operations performed by the hardware components and the methods as described above.

The processor or computer readable code, instructions, or software to control a processing device, processor, or computer to implement the hardware components, such as discussed in any of FIGS. 1, 8, and 15, and perform the methods as described above in any of FIGS. 2-7 and 9-14, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the computer readable code, instructions, or software and any associated data, data files, and data structures in a non-transitory manner and providing the processor or computer readable code, instructions, or software and any associated data, data files, and data structures to a processing device, processor, or computer so that the processing device, processor, or computer can execute the instructions. In one example, the processor or computer readable code, instructions, or software and any associated data, data files, and data structures are distributed over network-coupled computer systems so that the instructions and software and any associated data, data files, and data structures are stored, accessed, and executed in a distributed fashion by the processing device, processor, or computer.

As a non-exhaustive example only, an electronic device embodiment herein is the rendering apparatus discussed herein, may include a mobile device, such as a cellular phone, a smart phone, a wearable smart device, a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is not limited by the detailed description, but further supported by the claims and their equivalents, and all variations within the scope of the claims and their equivalents are to be construed as being included in the disclosure.

What is claimed is:

1. A rendering method, the method comprising:
generating a domain visibility stream indicating which domains of a plurality of domains for an input patch are visible;
generating domain information about one or more regions of the input patch based on the domain visibility stream; and
performing selective domain shading, using the domain information, on respective domains of the plurality of domains based on whether the respective domains are indicated as being visible by the domain visibility stream.

2. The method of claim 1, further comprising partitioning the input patch to generate the plurality of domains, the plurality of domains corresponding to the regions of the input patch.

3. The method of claim 1, wherein the generating of the domain visibility stream further comprises generating the domain visibility stream based on respective location information of a vertex corresponding to each of the plurality of domains.

4. The method of claim 3, wherein the generating of the domain visibility stream is based only on the respective location information of the vertex corresponding to each of the plurality of domains and depth information for comparison with vertex depth information for each of the respective location information to determine visibility of each vertex corresponding to the plurality of domains.

5. The method of claim 1, wherein the generating of the domain visibility stream further comprises generating the domain visibility stream by performing respective depth tests on each of the plurality of domains.

6. The method of claim 1, wherein, when a first domain set includes all domains of the plurality of domains that are determined to be visible and a second domain set includes all domains of the plurality of domains that are determined to be invisible, the domain visibility stream comprises:
an identifier of a domain included in whichever one of the first and second domain sets has a fewest number of domains; and
a reverse flag distinguishing whether the domain is determined to be a visible domain or determined to be an invisible domain.

7. The method of claim 1, wherein the performing of the selective domain shading comprises skipping domain shading on domains indicated as being invisible by the domain visibility stream.

8. The method of claim 1, further comprising:
generating a primitive assembly stream indicating whether at least one domain of the plurality of domains is assembled to a primitive; and
performing primitive assembly on a vertex corresponding to the at least one domain and obtained as a result of the performing the selective domain shading, based on the primitive assembly stream.

9. The method of claim 1, wherein the generating of the domain visibility stream is performed in a first rendering pipeline, and
the generating of the domain information and the performing of the selective domain shading are performed in a second rendering pipeline.

10. The method of claim 1, further comprising:
generating a vertex visibility stream respectively indicating whether each input vertex of the input patch is visible; and
selectively performing vertex shading on an input vertex of the input patch based on whether the vertex visibility stream indicates that the input vertex is visible.

11. The method of claim 10, wherein at least one of the input vertices of the input patch is an input control point of the input patch.

12. A rendering method, the method comprising:
generating a vertex visibility stream respectively indicating whether each of plural input vertices is visible; and
selectively performing vertex shading on an input vertex, of the plural input vertices, based on whether the vertex visibility stream indicates that the input vertex is visible, where the vertex shading is performed using vertex information about the input vertex.

13. The method of claim 12, further comprising:
generating a primitive assembly stream indicating whether at least one vertex of the plural input vertices is assembled to a primitive; and
performing primitive assembly on a vertex obtained as a result of the performing of the vertex shading, based on the primitive assembly stream.

14. The method of claim 13, wherein the vertex visibility stream and the primitive assembly stream are generated in a first rendering pipeline and vertex shading is performed only in the second rendering pipeline.

15. The method of claim 12, further comprising:
partitioning a patch, derived from a result of the vertex shading, to generate a plurality of domains, the plurality of domains corresponding to partitioned regions of the input patch;
generating a domain visibility stream indicating which domains of the plurality of domains for the patch are visible; and
performing selective domain shading on respective domains, of the plurality of domains, based on whether the respective domains are indicated as being visible by the domain visibility stream.

16. A rendering apparatus comprising:
one or more rendering pipelines respectively including a partitioning processing element and a domain shading processing element, configured to implement a first rendering pipeline sequence using a first rendering pipeline of the one or more rendering pipelines to generate a domain visibility stream indicating which of a plurality of domains for the input patch are visible regions and configured to implement a second rendering pipeline sequence using the first rendering pipeline or another rendering pipeline of the one or more rendering pipelines to generate domain information about one or more regions of the input patch based on the domain visibility stream and to perform selective domain shading, using the domain information, on respective domains of the plurality of domains based on whether the respective domains are indicated as being visible by the domain visibility stream.

17. The rendering apparatus of claim 16, wherein the partitioning processing element of the first rendering pipeline is configured to partition the input patch to identify the plurality of domains in the first rendering pipeline sequence.

18. The rendering apparatus of claim 16, wherein, in the first rendering pipeline sequence, the first rendering pipeline generates the domain visibility stream based on respective location information of a vertex corresponding to each of the plurality of domains.

19. The rendering apparatus of claim 16, wherein, in the first rendering pipeline sequence, the first rendering pipeline generates the domain visibility stream by performing respective depth tests on each of the plurality of domains.

20. The rendering apparatus of claim 16, wherein, in the second rendering pipeline sequence, the first rendering pipeline or the other rendering pipeline skips domain shading on domains indicated as being invisible by the domain visibility stream.

21. The rendering apparatus of claim 16, wherein, in the second rendering pipeline sequence, the first rendering pipeline generates a primitive assembly stream indicating whether at least one domain of the plurality of domains is assembled to a primitive, and the first rendering pipeline or the other rendering pipeline performs primitive assembly on a vertex corresponding to the at least one domain and obtained as a result of the selective domain shading, by using the primitive assembly stream.

22. The rendering apparatus of claim 16, wherein the first rendering pipeline and the other rendering pipeline each further include a vertex shading processing element, configured to generate, in the first rendering pipeline sequence, a vertex visibility stream respectively indicating which input vertex of the input patch is visible, and configured to selectively perform, in the second rendering pipeline sequence, selective vertex shading on an input vertex of the input patch based on whether the vertex visibility stream indicates that the input vertex is visible.

23. The rendering apparatus of claim 22, wherein at least one of the input vertices of the input patch is an input control point of the input patch.

24. A rendering apparatus comprising:
one or more rendering pipelines respectively including a vertex shader processing element, configured to implement a first rendering pipeline sequence using a first rendering pipeline of the one or more rendering pipelines to generate a vertex visibility stream respectively indicating which of plural input vertices is visible, and configured to implement a second rendering pipeline sequence using the first rendering pipeline or another rendering pipeline of the one or more rendering pipelines to selectively perform vertex shading on an input vertex, of the plural input vertices, based on whether the vertex visibility stream indicates that the input vertex is visible, where the vertex shading is performed using vertex information about the input vertex.

25. The rendering apparatus of claim 24, wherein the first rendering pipeline and the other rendering pipeline each further include a primitive assembly processing element, configured to generate, in the first rendering pipeline sequence, a primitive assembly stream indicating whether at least one vertex of the input vertices is assembled to a primitive, and configured to performs primitive assembly, in the second rendering pipeline sequence, on a vertex obtained as a result of the vertex shading based on the primitive assembly stream.

26. A non-transitory recording medium comprising processing code to control at least one processing device to implement the method of claim 1.
